(19) United States
(12) Patent Application Publication
(10) Pub. No.: US 2012/0201158 A1
(43) Pub. Date: Aug. 9, 2012

(54) PEER-TO-PEER / WAN ASSOCIATION CONTROL AND RESOURCE COORDINATION FOR MOBILE ENTITIES USING AGGREGATE NEIGHBORHOOD UTILITY METRICS

(75) Inventors: Stefan Geirhofer, San Diego, CA (US); Jaber Mohammad Borran, San Diego, CA (US); Anastasios Stamoulis, San Diego, CA (US); Siddhartha Mallik, San Diego, CA (US); Ravi Palanki, San Diego, CA (US); Naga Bhushan, San Diego, CA (US)

(73) Assignee: QUALCOMM INCORPORATED, San Diego, CA (US)

(21) Appl. No.: 13/364,271

(22) Filed: Feb. 1, 2012

Related U.S. Application Data
(60) Provisional application No. 61/439,052, filed on Feb. 3, 2011.
(60) Provisional application No. 61/441,972, filed on Feb. 11, 2011.

(51) Int. Cl. H04W 24/00; H04W 36/00

(52) U.S. Cl. 370/252; 370/331

(57) ABSTRACT

In a cellular wireless communication system, peer-to-peer (P2P) links between mobile devices are implemented, and controlled using an aggregate utility metric for a group of P2P and cellular links. A mobile node participating in a P2P link, or an eNB, may periodically broadcast an activity level indicator indicating a resource-dependent activity level of the link. The node may control the activity level in response to utility metrics received from members of neighboring P2P links to maximize an aggregate utility of the link and the neighboring P2P links sharing at least a subset of resources of a common frequency spectrum. Formation or termination of P2P links may be controlled in response to comparing a calculated achievable utility value to a current utility value of a link, and taking action calculated to maximize the aggregate utility value.

### CROSS-REFERENCE TO RELATED APPLICATIONS

This application claims priority pursuant to 35 U.S.C. §119(e) to U.S. provisional application Ser. No. 61/439,052 filed Feb. 3, 2011 and to U.S. provisional application Ser. No. 61/441,972 filed Feb. 11, 2011, which applications are hereby incorporated by reference, in their entireties.

### FIELD

The present application relates generally to wireless communications, and more specifically to resource coordination in peer-to-peer direct connection for mobile entities.

### BACKGROUND

The 3rd Generation Partnership Project (3GPP) Long Term Evolution (LTE) represents a major advance in cellular technology and is the next step forward in cellular 3G services as a natural evolution of Global System for Mobile communications (GSM) and Universal Mobile Telecommunications System (UMTS). The LTE physical layer (PHY) is a highly efficient means of conveying both data and control information between an evolved Node-B (eNB) and mobile entities (MEs), such as, for example, access terminals (ATs) or user equipment (UE). The LTE PHY employs some advanced technologies that are new to cellular applications. These include Orthogonal Frequency Division Multiplexing (OFDM) and Multiple Input Multiple Output (MIMO) data transmission. In addition, the LTE PHY uses Orthogonal Frequency Division Multiple Access (OFDMA) on the downlink (DL) and Single-Carrier Frequency Division Multiple Access (SC-FDMA) on the uplink (UL). OFDMA allows data to be directed to or from multiple users on a subcarrier-by-subcarrier basis for a specified number of symbol periods.

Examples of older wireless communication systems widely deployed to provide various types of communication content such as voice and data include Code Division Multiple Access (CDMA) systems, including CDMA2000, Wideband CDMA, Global System for Mobile communications (GSM), and Universal Mobile Telecommunication System (UMTS). These wireless communication systems and LTE systems generally use different radio access technologies (RATs) and communication protocols, operate at different frequency bands, provide different quality of service (QoS), and offer different types of services and applications to the system users.

In a direct wireless connection, a first wireless device transmits an uplink wireless signal directly to a second wireless device, which receives and processes the wireless signal. Examples of direct wireless connections include connections from an UE to an eNB in LTE or other wireless communications protocols, or peer-to-peer connections between devices as used in non-cellular protocols such as WiFi Direct or Bluetooth. In traditional wide area networks (WANs), including LTE and other cellular wireless communications systems, direct communication among UEs or other mobile entities is not supported. Instead, mobile-to-mobile traffic is first transmitted by the source UE to its serving eNB and subsequently by a possibly different eNB to the destination UE. While this approach is natural and proven to be effective in many cases (especially if UEs are located far apart from each other), it may present unnecessary limitations in certain circumstances.

### BRIEF DESCRIPTION OF THE DRAWINGS

FIG. 1 is a diagram showing an example of a multiple access wireless communication system.

FIG. 2 is a block diagram showing an example of a communication system as used in LTE to communicate between a wireless transmitter and a wireless receiver.

FIG. 3 illustrates a wireless communication system configured to support a number of users.

FIG. 4 is a network diagram illustrating comparative examples of a direct peer-to-peer connection between mobile entities and an indirect connection through a radio access network.

FIG. 5 illustrates the comparative examples as described for FIG. 5, wherein the radio access network utilizes LTE architecture.

FIG. 6 illustrates an example of peer-to-peer (P2P) links in a neighborhood served by one or more base stations of a radio access network.

FIG. 7 is a sequence diagram illustrating an example of a P2P resource coordination procedure using aggregate neighborhood utility metrics based on activity level indicators from transmitting nodes of neighboring P2P links.

FIG. 8 is a sequence diagram illustrating an example of the P2P resource coordination procedure shown in FIG. 7, including additional activity at an eNB and a UE not participating in a P2P link.

FIG. 9 is a sequence diagram illustrating an example of a P2P resource coordination procedure using aggregate neighborhood utility metrics based on activity level indicators from receiving nodes of neighboring P2P links.

FIG. 10 is a sequence diagram illustrating an example of the P2P resource coordination procedure shown in FIG. 9, including additional activity at an eNB and a UE not participating in a P2P link.

FIG. 11 illustrates an example of a P2P resource coordination method using aggregate neighborhood utility metrics for performance by a node of a P2P link that periodically broadcasts an activity level indicator.

FIGS. 12-14 illustrate examples of alternative embodiments and additional operations pertinent to the method illustrated by FIG. 11.

FIG. 15 illustrates an example of a P2P resource coordination method using aggregate neighborhood utility metrics for performance by a node of a P2P link that periodically receives an activity level indicator broadcast from a different P2P link.

FIGS. 16-18 illustrate examples of alternative embodiments and additional operations pertinent to the method illustrated by FIG. 15.

FIG. 19 illustrates an example of a P2P resource coordination method using aggregate neighborhood utility metrics for performance by an eNB operating in a neighborhood including at least one P2P link.

FIGS. 20-21 illustrate examples of alternative embodiments and additional operations pertinent to the method illustrated by FIG. 19.

FIG. 22 illustrates an example of a method supporting P2P resource coordination using aggregate neighborhood utility metrics, for performance by a UE that is not itself participating in a P2P link and receives a utility metric from a neighboring P2P node.

FIG. 23 illustrates examples of alternative embodiments and additional operations pertinent to the method illustrated by FIG. 22.

FIG. 24 illustrates an example of a method supporting P2P resource coordination using aggregate neighborhood utility metrics, for performance by a UE that is not itself participating in a P2P link and receives an activity level indicator from a neighboring P2P node.

FIG. 25 illustrates examples of alternative embodiments and additional operations pertinent to the method illustrated by FIG. 24.

FIG. 26 illustrates an example of an apparatus for performing the method of FIG. 11.

FIG. 27 illustrates an example of an apparatus for performing the method of FIG. 15.

FIG. 28 illustrates an example of an apparatus for performing the method of FIG. 19.

FIG. 29 illustrates an example of an apparatus for performing the method of FIG. 22.

FIG. 30 illustrates an example of an apparatus for performing the method of FIG. 24.

FIG. 31 illustrates mobile entities in communication via a radio access network and via direct wireless connections.

FIG. 32A illustrates an association change (handover) from P2P to WAN association, for IoT-projection based power control.

FIG. 32B illustrates an association change (handover) from WAN to P2P association, for IoT-projection based power control.

FIG. 33A illustrates an association change (handover) from P2P to WAN association, for Tx-PSD based power control.

FIG. 33B illustrates an association change (handover) from WAN to P2P association, for Tx-PSD based power control.

FIG. 34 shows a methodology for an association change (handover) from P2P to WAN, in the context of IoT-projection based power control.

FIG. 35 shows a methodology for an association change (handover) from WAN to P2P, in the context of IoT-projection based power control.

FIG. 36 shows a methodology for an association change (handover) from P2P to WAN, in the context of Tx-PSD based power control.

FIG. 37 shows a methodology for an association change (handover) from WAN to P2P, in the context of Tx-PSD based power control.

FIG. 38 shows an apparatus for an association change (handover) from P2P to WAN, in the context of IoT-projection based power control, in accordance with the methodology of FIG. 34.

FIG. 39 illustrates an apparatus for an association change (handover) from WAN to P2P, in the context of IoT-projection based power control, in accordance with the methodology of FIG. 35.

FIG. 40 illustrates an apparatus for an association change (handover) from P2P to WAN, in the context of Tx-PSD based power control, in accordance with the methodology of FIG. 36.

FIG. 41 illustrates an apparatus for an association change (handover) from WAN to P2P, in the context of Tx-PSD based power control, in accordance with the methodology of FIG. 37.

### DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. However, such embodiment(s) may be practiced without all specific details in some embodiments. In other instances, well-known structures and devices are shown in block diagram form in order to facilitate describing one or more embodiments.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP), including technical specifications abbreviated herein as “TS” plus a specification number. CDMA2000 is described in documents from an organization named “3rd Generation Partnership Project 2” (3GPP2). These various radio technologies and standards are known in the art. In the following description, for reasons of conciseness and clarity, terminology associated with W-CDMA and LTE standards, as promulgated under the 3GPP standards by the International Telecommunication Union (ITU), is used. It should be emphasized that the techniques described herein are applicable to other technologies, such as the technologies and standards mentioned above.

Single-Carrier Frequency Division Multiple Access (SC-FDMA), which utilizes single carrier modulation and frequency domain equalization, has similar performance and essentially the same overall complexity as those of OFDMA systems. An SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. SC-FDMA is used for uplink multiple access in 3GPP LTE, or Evolved UTRA.

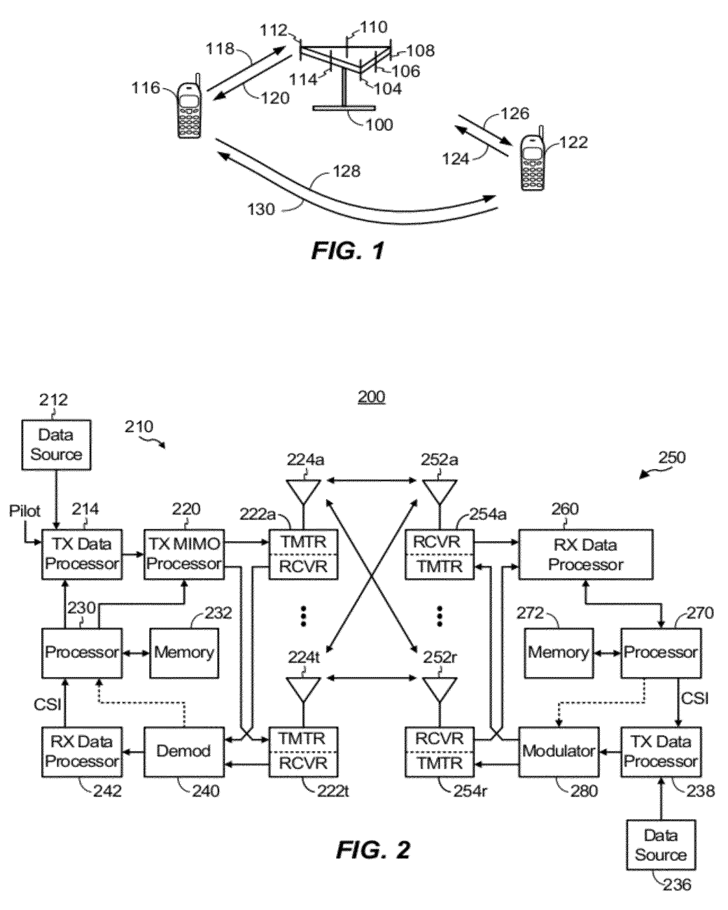

Referring to FIG. 1, a multiple access wireless communication system according to one embodiment is illustrated. An access point 100 (e.g., base station, evolved Node-B (eNB), or the like) includes multiple antenna groups, one including 104 and 106, another including 108 and 110, and an additional one including 112 and 114. In FIG. 1, two antennas are shown for each antenna group; however, more or fewer antennas may be utilized for each antenna group. A mobile entity (ME) for example UE 116 is in communication with the antennas 112 and 114, where the antennas 112 and 114 transmit information to the mobile entity 116 over a forward link 120 and receive information from the mobile entity 116 over a reverse link 118. A mobile entity 122 is in communication with the antennas 104 and 106, where the antennas 104 and 106 transmit information to the mobile entity 122 over a forward link 126 and receive information from the mobile entity 122 over a reverse link 124.

In addition, the mobile entity 116 is in communication with the mobile entity 122 using a forward direct peer-to-peer link 128 and reverse direct peer-to-peer link 130. In a Frequency Division Duplex (FDD) system, the communication links 118, 120, 124, 126, 128 and 130 may use different frequencies for communication. For example, the forward link 120 may use a different frequency than that used by the reverse link 118.

Each group of antennas and/or the area in which they are designed to communicate is often referred to as a sector of the access point. In certain embodiments, antenna groups each are designed to communicate with mobile entities in a sector, of the areas covered by the access point 100.

In communication over the forward links 120 and 126, the transmitting antennas of the access point 100 may utilize beamforming in order to improve the signal-to-noise ratio of forward links for the different mobile entities 116 and 122. Also, an access point using beamforming to transmit to mobile entities scattered randomly through its coverage causes less interference to mobile entities in neighboring cells than an access point transmitting through a single antenna to all its mobile entities.

An access point may be a fixed station used for communicating with the terminals, and may also be referred to as an access point, a Node-B, an eNB, a Home Node-B, or some other terminology. A mobile entity may also be referred to as an access terminal (AT), a user equipment (UE), a mobile station, a wireless communication device, terminal, or the like.

The communication links 118, 120, 124, 126, 128 and 130 may all use a common radio technology, for example, a E-UTRAN/LTE technology modified to enable direct communication between mobile entities as well as between mobile entities and eNBs. Further details concerning useful modifications are provided herein. Such modifications may enable mobile entities 116, 122 to communicate with each other while minimizing use of communications network resources from the access point 100 upwards. Mobile entities within radio link range of one another may therefore provide a range of services to each other without burdening network resources, and without diminishing the mobile entities' capabilities of communicating conventionally using network resources.

FIG. 2 is a block diagram of an embodiment of a transmitter system 210 (also known as an access point) and a receiver system 250 (also known as a mobile entity) in a MIMO system 200. According to the technology disclosed herein, the transmitter system 210 may also comprise a mobile entity operating in a peer-to-peer communication mode with the receiver system 250. At the transmitter system 210, traffic data for a number of data streams is provided from a data source 212 to a transmit (TX) data processor 214.

In an embodiment, each data stream is transmitted over a respective transmit antenna. The TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., Binary Phase Shift Keying (BPSK), Quadrature Phase Shift Keying (QSPK), M-ary Phase-Shift Keying (M-PSK), or Multi-Level Quadrature Amplitude Modulation (M-QAM)) selected for that data stream to provide modulation symbols. The data rate, coding, and modulation for each data stream may be determined by instructions performed by a processor 230, which may be in operative communication with a memory 232.

The modulation symbols for the data streams are then provided to a TX MIMO processor 220, which may further process the modulation symbols (e.g., for OFDM). The TX MIMO processor 220 then provides N_{T} modulation symbol streams to N_{T} transmitters (TMTR) 222a through 222t. In certain embodiments, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from the transmitters 222a through 222t are then transmitted from N_{T} antennas 224a through 224t, respectively.

At the receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

A RX data processor 260 then receives and processes the N_{R} received symbol streams from the N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by the RX data processor 260 is complementary to that performed by the TX MIMO processor 220 and the TX data processor 214 at the transmitter system 210.

A processor 270 periodically determines which pre-coding matrix to use. The processor 270 formulates a reverse link message comprising a matrix index portion and a rank value portion, and may be in operative communication with a memory 272. The memory 272 may hold coded instructions, which when executed by the processor 270 or other processors of the receiver 250, cause the receiver to perform methods as described herein for performance by a mobile entity, or by a receiving node of a P2P link.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by the transmitters 254a through 254r, and transmitted back to the transmitter system 210.

At the transmitter system 210, the modulated signals from the receiver system 250 are received by the antennas 224, conditioned by the receivers 222, demodulated by a demodulator 240, and processed by a RX data processor 242 to extract the reserve link message transmitted by the receiver system 250. The processor 230 then determines which pre-coding matrix to use for determining the beamforming weights then processes the extracted message. The memory 232 may hold coded instructions, which when executed by the processor 230 or other processors of the transmitter 210, cause the transmitter to perform methods as described herein for performance by a network entity/NodeB or by a transmitting node of a P2P link.

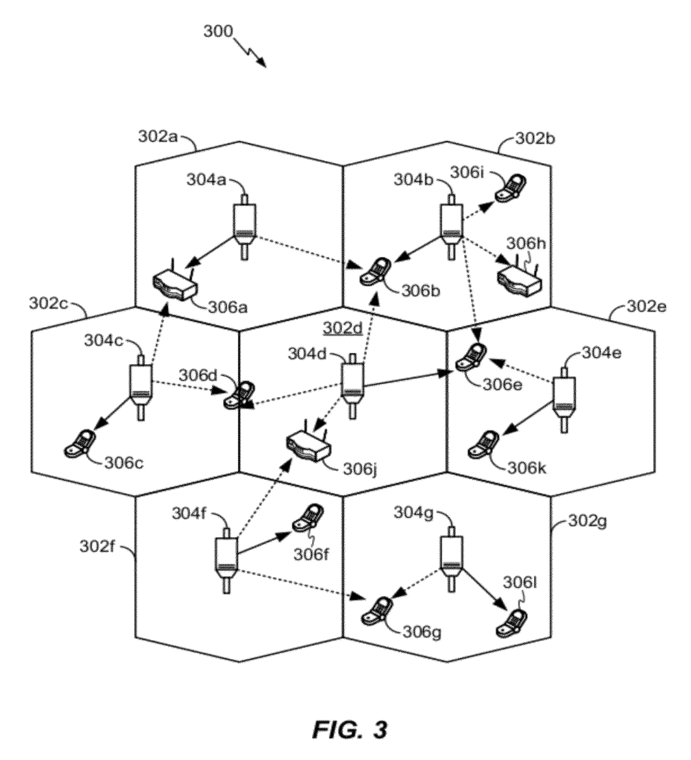

FIG. 3 illustrates a wireless communication system 300, configured to support a number of users, in which the teachings herein may be implemented. The system 300 provides communication for multiple cells 302, such as, for example, macro cells 302a-302g, with each cell being serviced by a corresponding access node 304 (e.g., access nodes 304a-304g). An access node may sometime be called an e-eNB (eNB) or more generally, a eNB. As shown in FIG. 3, mobile entities 306 (e.g., mobile entities 306a-3061) may be dispersed at various locations throughout the system over time. Each mobile entity 306 may communicate with one or more access nodes 304 on a forward link (“FL”) and/or a reverse link (“RL) at a given moment, depending upon whether the mobile entity 306 is active and whether it is in soft handoff (if applicable), for example. The wireless communication system 300 may provide service over a large geographic region. For example, macro cells 302a-302g may cover a few blocks in an urban or suburban neighborhood or a few square miles in a rural environment.

In accordance with aspects of the embodiments described herein, a mobile entity may report measurements of the last serving cell and/or neighbor cells in one or more networks, such as, for example, LTE, Universal Terrestrial Radio Access Network (UTRAN), GSM EDGE (Enhanced Data rates for GSM Evolution) Radio Access Network (GERAN), and/or CDMA2000 networks. The reported measurements may be used by the network to collect information regarding radio link failures (RLFs) to optimize the deployment and tuning of the network. It is again noted that, while terminology associated with LTE standards, as promulgated under the 3GPP standards, is used herein, the techniques described herein are applicable to other technologies and standards.

Embodiments described herein concern resource coordination techniques for direct peer-to-peer communications between mobile entities, without detriment to services provided over mobile entities' radio access network. Direct P2P communication may offer efficiency benefits over traditional communication via a WAN if mobiles are close-by. Specifically, efficiency may improve because the path loss between both nodes of a P2P link may be substantially smaller than to either of the eNBs. In addition, efficiency may benefit because only a single transmission “hop” is needed to transmit information from one mobile entity to another, instead of requiring separate transmissions on the forward and reverse link, respectively as done in traditional wireless systems. An important aspect of P2P capability as contemplated herein is co-existence with traditional communication between mobile entities via a WAN within the same wireless communications system. That is, P2P operations should not prevent or impede use of the same mobile entities to communicate via a WAN, when appropriate.

Although examples and terminology associated with the 3GPP/LTE standards are used herein, the techniques described herein may be implemented using other technologies and standards. Several different approaches are described in detail below. These approaches may be used individually, or in any operable combination for resource coordination affecting direct peer-to-peer communications between mobile entities. Prior to describing particulars of resource coordination in peer-to-peer 3GPP/LTE compatible communication between mobile entities, other aspects of peer-to-peer communication are described to provide an example of technological context and application.

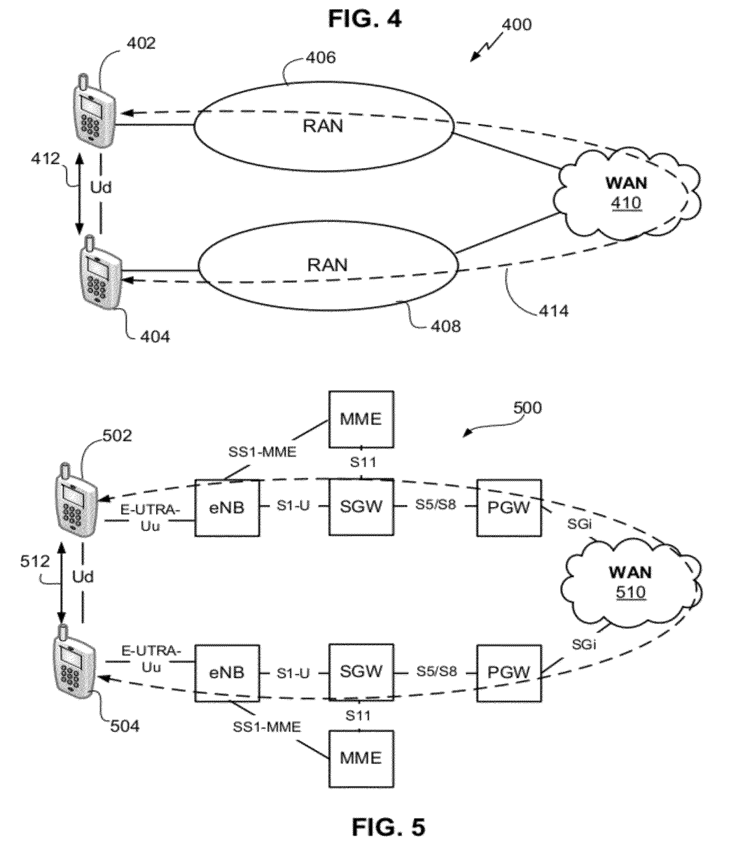

FIG. 4 illustrates comparative examples of a direct peer-to-peer connection 412 between mobile entities 402, 404 in a combined wireless and wired RAN/WAN system 400. The direct connection 412 is coexisting with an indirect connection 414 through radio access networks 406, 408 and through an IP Multimedia Subsystem (IMS), Internet, or other Wide Area Network (WAN) 410 in the system 400. The peer-to-peer connection 412 may use a special interface herein referred to as “Ud.” System 400 exemplifies a general architecture reference model for two UEs 402, 404 that establish communication for peer-to-peer service either directly or via a WAN. As shown, a direct connection between UEs 402, 404 may be established using the interface Ud independently of, and without detriment to, the underlying radio access network or networks 406, 408.

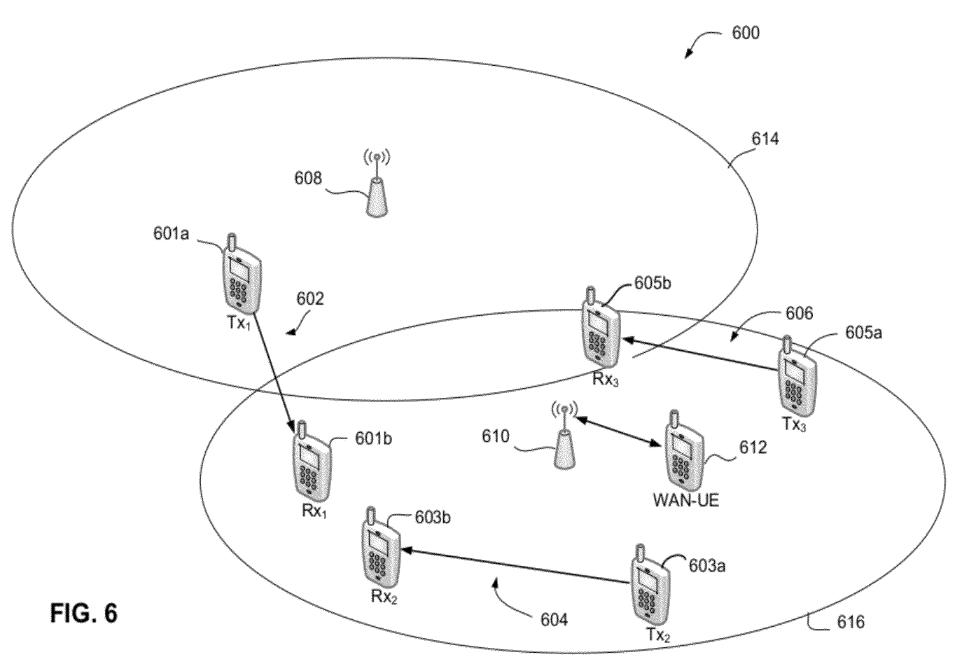

FIG. 5 illustrates the comparative examples as described for FIG. 4 in a combined wireless and wired RAN/WAN system 500, wherein the radio access networks for the respective mobile entities 502, 504 both utilize an LTE architecture, comprising interfaces and illustrative components as shown in FIG. 6. In both systems 400, 500, the new interface Ud is defined for the direct connection between the peer UEs. Details concerning the new interface Ud are beyond the scope of the present disclosure, which concerns P2P resource coordination.

Peer UEs may communicate over the LTE WAN using existing procedures, for example as described in 3GPP TS 36.300 and TS 23.401. Both signaling and user data are carried on the Uu interface. To communicate with the target UE over the WAN, the source UE needs to know the target UE's WAN IP address. The source UE may use any suitable method to determine a target WAN IP address. For example, the UE use a proprietary, application specific method (e.g., Skype) determine the WAN IP address of the target UE for communication. These types of applications generally also support communication across Network Address Translators (NATs) and firewalls. In the alternative, or in addition, the UE may determine the IP address through a DNS query. Communications over the WAN may be used to set up a direct connection, in the alternative to using direct communications.

Establishment of a direct connection by the peer mobile entities may adopt certain existing LTE procedures using a semi-symmetrical approach, also called an asymmetrical approach. In this approach, a UE that initiates the direct connection operates as a client UE, which plays the traditional UE role in certain NAS-like and RRC procedures for transactions between a UE and eNB. The other UE, which does not initiate the direct connection, operates as a manager UE, which plays the equivalent eNB role in certain NAS-like and RRC procedures. In addition, the UE that operates as the transmitter of uplink signaling to the receiving UE of the P2P link is referred to herein as the “transmitter” or “transmitting UE.” Conversely, the UE that operates as the receiver of uplink signaling from the transmitting UE of the P2P link is referred to herein as the “receiver” or “receiving UE.”

FIG. 6 shows a system 600 comprising mobile entities 601a, 601b, 603a, 603b, 605a, 605b, and 612 in communication with one or more eNBs 610, 608 of a radio access network and via direct P2P wireless connections sometimes called “links” 602, 604 and 606. The depicted example illustrates (1) all UE's participating in the links 604, 606 camped at a cell of the same eNB 610 and (2) UEs participating in the link 602 camped at cells for respective different eNBs 608, 610.

### P2P Resource Coordination for Mobile Entities Using Aggregate Neighborhood Utility Metrics

The present disclosure describes a resource coordination technique for P2P links that share a common frequency spectrum, or at least a subset of a common frequency spectrum. The case in which the frequency band is shared with a WAN, which may facilitate P2P communication in its coverage, is explicitly considered; however the presence of the WAN is not required for the presented resource coordination technique to function. A key benefit that may be provided by the WAN is the ability to relay traffic between P2P devices in case direct communication is not preferable from a system performance viewpoint. In the absence of the WAN all traffic is assumed to be transmitted directly between P2P devices.

Throughout this disclosure it is assumed that a set of resources in either time, frequency, or some other domain may be assigned to P2P links. Resources are frequently identified with subframes, i.e., time domain interlaces, in the remainder of this document. However, the methods and algorithms presented herein may equally apply to other orthogonal resources.

The resource coordination technique provides a means for assigning resources to certain P2P links such as to optimize system performance as quantified by a selected utility metric. The algorithm is able to function with a wide variety of utility metrics, some of which will be discussed as examples later in this disclosure. As used herein, “utility” refers to communications performance of a P2P communication link or link with an eNB, for example, a data rate, fairness, quality of service, or other communications performance parameter or combination of parameters. A “utility metric” means a quantitative indicator of utility mapped in some predictable fashion to the indicated utility. A utility metric may be relative or absolute in character. A “relative utility metric” may be determined by a neighbor P2P link, and means an estimated amount by which a change in activity level of a link will affect utility of the neighbor link. An “absolute utility metric” may also be determined by a neighbor P2P link, and means a measure of current utility of the neighbor link.

Throughout this disclosure, resources are assigned to unidirectional communication links between two P2P devices, subject to additional power control constraints on each resource. The requirement of unidirectionality refers to the fact that assigning a resource for a link from P2P Device ‘A’ to P2P Device ‘B’ may not be available for communication from Device B to Device A. Instead, a separate resource may need to be negotiated for communication from P2P Device B to A. It should be noted, however, that if constraints need to be imposed on what resources are available for communication in either direction, such constraints may be incorporated into the framework to perform resource coordination based on a joint utility metric, which captures the system performance in both directions.

Resources assigned to a link are to be used subject to a power control framework which ultimately determines the transmission power of the P2P transmitter of each link. The resource coordination technique proposed in this disclosure is amenable to a variety of different power control frameworks, some of which are described in this disclosure. Many extensions/variations of these frameworks may be readily incorporated.

The message exchange between P2P links in support of this resource coordination framework is briefly addressed in this disclosure to illustrate the operation of the algorithm. However, the resource coordination technique does not rely on a specific type of message exchange. For example, messages may be transmitted over-the-air or relayed through the WAN, if available.

The present section pertains to resource coordination in a mixed P2P/WAN environment, and the association of P2P devices is assumed given. Specifically, by association we mean whether a P2P device performs direct communication with its intended P2P receiver or whether it associates with the WAN and has the traffic destined for the P2P receiver relayed through the WAN. The technique presented herein may be extended to also allow for association changes based on aggregate utility metrics. Such extensions are treated in a subsequent section of the disclosure.

### Measurement Assumptions for the Resource Coordination Algorithm

The resource coordination mechanism described in this disclosure assumes that P2P transmitters possess information concerning the (long-term) channel conditions between themselves and neighboring victim P2P receivers, i.e., receiving P2P nodes belonging to a neighboring P2P link. Again, it should be noted that since the resource coordination technique addresses unidirectional P2P links, transmitter and receiver are well-defined. In practice, the path loss information between the links may be obtained through the transmission of pilot or reference signals. In addition to pilot tones such signals may also transmit identifying information that allows the neighboring P2P nodes to identify them. This may be used, for example, to facilitate negotiations with the neighboring P2P nodes for resource coordination purposes.

### Utility-Based Resource Coordination Framework

The resource coordination framework presented in this disclosure relies on a power control framework, which forms the basis for forecasting achievable rates and system utilities. While the algorithm itself does not rely on a specific choice of power control, several examples are provided below for illustration. The resource coordination framework itself is first addressed assuming that no WAN is present, for simplicity. After this, the case of WAN presence is discussed in more detail, followed by an example of the signaling timeline.

### Power Control Mechanisms

It is necessary to define a common power control framework in order to enable neighboring links to assess the impact of their interference on system performance. In general, almost any power control framework should be amenable to the resource coordination technique described in this disclosure as long as it allows for a finite set of possible power “settings.” In order to provide concrete examples, we provide three examples of power control frameworks that may be incorporated into this framework, in the three paragraphs immediately following. The present technology is not limited by these examples.

Tx-PSD based power control. This power control framework assumes that each P2P transmitter may select a finite number of Transmission Power Spectral Density (Tx-PSD) levels for transmission. The Tx-PSD chosen by a transmitter not only impacts the performance of the desired link between itself and its receiver, but also increases interference to neighboring links. This tradeoff is captured through the exchange of utility metrics as described as part of the resource coordination procedure later in this disclosure.

IoT-projection based power control. Alternatively, a P2P receiver may request that adjacent P2P transmitters enforce a certain Interference-over-Thermal (IoT) target at the P2P receiver (again, there may be a finite set of IoT levels that may be requested). The IoT target may be enforced at P2P transmitters of neighboring P2P links based on open-loop projection by selecting its Tx-PSD such that the most restrictive IoT target is met.

Pathloss compensation based power control. Another possibility is for each transmitter to perform fractional pathloss compensation to its receiver on each resource, with a resource-dependent set of pathloss compensation factors (e.g., offset and exponent). The path-loss compensation factors (α,β) are used to compute the tx-power according to the equation

T×Power (in dB)=α+β×PathLoss (in dB)

Note that the parameter-setting (α,β)=(−∞,0) corresponds to disallowing the use of a resource. A special case of the pathloss compensation-based power control is obtained by defining two possible parameter-settings for any resource (ON or OFF states), where OFF state for a resource corresponds to (α,β)=(−∞,0) for that resource.

The above examples illustrate that different power control frameworks may be used with the resource coordination framework. An important requirement, however, is that transmit power or interference level are selected from a finite set of possibilities as the algorithm takes steps on those values based on maximizing aggregate utility metrics. It may be beneficial to have a zero power transmit (or equivalently infinite IoT) setting as part of this set of power control levels to model the case in which a link does not use a given resource.

An important special case of the above framework is the scenario in which exactly two power settings are available, one of which corresponds to not using a given resource. This case is important since it may be understood as a simple ON/OFF type of power control which may help to reduce complexity in some cases.

Key concepts behind the presented resource partitioning algorithm are transparent to the choice of the above power control scheme. In the present disclosure, in order not to duplicate the same concepts for all choices of power control schemes, the term “activity level” is used to refer to power control settings for a specific P2P link. For example, for the case of Tx-PSD based power control, increasing the activity level of a link corresponds to increasing the Tx-PSD. For the IoT-projection based power control framework, on the other hand, it may correspond to decreasing the IoT target at the link's receiver, thereby forcing other links to reduce interference. For the pathloss-compensation scheme, increasing the activity level may be identified with a setting in which an increased portion of the pathloss is compensated for. Finally, for an ON/OFF type of power control, there may only be two activity levels, corresponding to using or not using the resource, respectively.

### Resource Coordination Framework

The resource coordination algorithm is based on a power control framework similar to the examples discussed herein above. Specifically, since the power control for each link uses a finite set of admissible power levels (or alternatively IoT targets), each P2P link may compute its performance subject to changes in the power level of either itself or neighboring links. By computing these utility metrics for certain combinations and by exchanging these metrics, it is possible to compute an aggregate utility metric that may be optimized by the P2P links in a distributed fashion.

In particular, P2P links compute the utility for their own link, assuming that a single one of its neighbors changes its power control level by one step in either direction. Here, “step” refers to incremental differences between adjacent levels of the finite set of admissible power levels. This change in utility may be computed in a straightforward fashion by first evaluating the impact that the power level change of a specific neighbor has on the forecasted rate of the P2P link and then mapping this estimated rate to a utility metric. As a special case, a change in power control levels may include ceasing transmission.

Each P2P link computes the above utility metrics for a select group of neighbors that may be its most dominant interferers, and exchanges the metrics with each of these neighbors. Conceptually, information is applied in a unicast fashion, i.e., the utility change conditioned on a change in the power setting of P2P neighbor link ‘A’ is needed at neighbor link ‘A’ only and is not used for other P2P links at the same time. Nevertheless, the unicast nature of the information itself does not mandate that the signaling need occur in a unicast fashion; it may also occur in a broadcast manner if deemed beneficial for some reason. The set of neighboring links with which negotiations should take place may be determined based on long term pathloss measurements.

Referring again to FIG. 6, three P2P links 602, 604 and 606 that perform resource coordination amongst each other are depicted. Based on the above discussion, the following utility metrics may be received by Link 602 and used for determining whether to change its transmit power: Link 604 (i.e., one of its nodes 603a, 603b) computes the impact on its utility if Tx₁ 601a increased/decreased its activity level by one step, and sends the corresponding utility values to one of the nodes 601a, 601b of Link 602. Similarly, Link 606 computes the same utility metrics, again conditioned on a change in the activity level of Link 602. Based on receiving the utility metrics, and taking into account the impact on its own utility, Link 602 may then compare the aggregate utilities associated with the changes in its own activity level. It is important to note that Link 602 also sends utility messages to Links 604 and 606. In the above example, only the utility messages destined for Link 602 from its neighbors were considered. As used herein, a P2P “link” is comprised of a transmitting node and a receiving node. As used herein, an activity performed by a link may be performed by its transmitting node, receiving node, or some combination of transmitting and receiving nodes, unless otherwise indicated.

The above procedure is performed independently by each of the P2P links. In order to avoid inconsistent network states throughout the P2P links, a P2P link broadcasts its current power level setting to neighboring nodes, so that it becomes known to neighbors if and when neighboring nodes make changes to their activity level based on the above procedure.

Mathematically, the maximization of the aggregate utility metric may be expressed as follows. Using the setup in FIG. 6, let A_{n,r} denote an activity level on the r-th resource (e.g., r-th interlace) chosen by the n-th P2P link, where each activity level A_{n,r} is chosen from a discrete set of possible values {a[1], a[2], . . . , a[K]}. Note that the combination of activity levels {A_{n,r}|1≦n≦N} chosen by all the P2P links on a given resource r, along with the knowledge of path loss between transmitters and receivers, determines the transmit power P_{n,r} of each P2P transmitter and the normalized interference level IoT_{n,r} at each P2P receiver, on that resource. In other words, the set of activity levels {A_{n,r}|1≦n≦N} selected for each link determines the channel quality (SINR) of each P2P link on the given resource.

To simplify notation in the following, let us for convenience define

Aₜ={A_{n,r}=a|j_{n,r}[t]|,1≦n≦N, 1≦r≦R}

as the resource partitioning state at time t. In the following we consider the utility impact that results from changing this state by having a specific link increase/decrease its activity level for a certain resource r. Specifically, let

Aₜ[n,r,+]={A_{n,r}=a[j_{n,r}[t]+1]; A_{n′,r′}=a[j_{n,r}],∀(n′,r′)≠(n,r)}

define the resource partitioning after increasing the activity level of Link n on resource r by one step. Likewise,

Aₜ[n,r,−]={A_{n,r}=a[j_{n,r}[t]−1]; A_{n′,r′}=a[j_{n,r}],∀(n′,r′)≠(n,r)}

corresponds to decreasing the resource partitioning state of Link n on resource r by one step.

In the following let us consider the messaging and decision procedure to determine whether a Link n should modify its activity level. To this end, as described before, neighbors of Link n may compute the utility impact of this change in resource partitioning. Specifically, Link m, which is a neighbor of Link n, may find the utility

$${U}_{t} ( m \vert {A}_{t} [ n , r , + ] ) = \frac{{R}_{t + 1} ( m \vert {A}_{t} [ n , r , + ] )}{{T}_{t} ( m )}$$

where the term in the numerator denotes the anticipated achievable rate of Link m in the (t+1)-th negotiation period, conditioned on Link n increasing its activity level on resource r by one step at the end of negotiation period t. The term in the denominator, corresponds to the throughput experienced so far and is included to achieve proportional fairness. It should be noted that other fairness criteria and utility metrics may be considered in a straightforward fashion by modifying the above definition appropriately.

In addition to the above equation, the utility Uₜ(m|Aₜ[n,r,−]) corresponding to a decrease in the activity level of Link n on resource r is also computed, as is Uₜ(m|Aₜ) which corresponds to no change in the resource partitioning state. The utilities computed under the assumptions stated above need to be conveyed to Link n. Specifically, the utility messages sent from Link m to Link n have the following format

M_{m→n; t}[r,+]=Uₜ(m|Aₜ[n,r,+])−Uₜ(m|Aₜ)

M_{m→n; t}[r,−]=Uₜ(m|Aₜ[n,r,−])−Uₜ(m|Aₜ)

and are exchanged on a per-resource basis. Link n which receives the messages then computes the aggregate utility by summing over all the utility messages received by its neighbors associated with increasing the activity level of Link n on resource r and factoring in its own utility change

$${AU}_{t} ( n , r , + ) = {M}_{n \to n ; t} [ r , + ] + {\sum }_{m} {M}_{m \to n ; t} [ r , + ]$$

In the above equation, the first term corresponds to the utility change associated with Link n itself which is computed in the same fashion as the other utility metrics but clearly need not be signaled. The summation in the above equation is over all neighbors m of Link n.

Similarly, the aggregate utility associated with a decrease in the activity level is obtained as

$${AU}_{t} ( n , r , - ) = {M}_{n \to n ; t} [ r , - ] + {\sum }_{m} {M}_{m \to n ; t} [ r , - ]$$

The aggregate utility metrics capture the impact of increasing or decreasing the activity level of the n-th P2P link on resource r, to all the P2P links in the neighborhood of the n-th link and is used to update the activity level of the P2P link on each resource, over the next time interval.

Specifically, Link n may first identify the resource associated with the largest change in aggregate utility. In the following assume that this resource is r. Then, if

AU[n,r,+]>max(Δₘᵢₙ,AU[n,r,−]),

the n-th P2P link uses the higher activity level a[j_{n,r}+1] on resource r, over the next time-interval t+1. On the other hand, if

AU[n,r,−]>max(Δₘᵢₙ,AU[n,r,+]),

then the n-th P2P link uses the lower activity level a[j_{n,r}−1] on resource r, over the next time-interval t+1. Otherwise, the n-th P2P link retains its current activity level a[j_{n,r}] on resource r over the next time-interval t+1. Note that the parameter Δₘᵢₙ≧0 represents the minimum utility improvement needed for a P2P link to change its activity level. The new activity level selected by each P2P link is announced to the neighboring P2P links, to facilitate data communication during the next time interval, and to compute resource coordination messages towards the end of the (t+1)-th time interval.

The above procedure allows for at most one change of activity level over all resources. While it may be possible to change the activity level of multiple resources in the same negotiation period, this may potentially lead to inaccuracies as the utility changes are computed conditioned on the change of the activity level for a single resource. An extension to changing the activity level of multiple resources at the same time may be possible, however, and may for example be facilitated through additional signaling.

It should also be noted that only utility differences (i.e., relative utility metrics) were exchanged in the above equations in order to capture the utility difference compared to keeping the same resource partitioning state. It is, however, also possible to exchange absolute utility metrics, i.e., by not subtracting the current utility value, if this is deemed preferable.

So far, P2P links have been considered as a single entity without breaking down the specific functions that P2P transmitter and receiver of a link perform. While the key concepts presented in this disclosure do not rely on a specific breakdown of this functionality, some examples are provided in the following as specific embodiments.

Key functions that have to be provided by the P2P links in this resource coordination framework is (1) to broadcast the current activity level of a link in order to inform neighboring links of the current resource partitioning state and (2) the computation and exchange of utilities in support of maximizing the aggregate utility metric. The breakdown of where these functions are performed actually depends on the power control framework, as explained in the following. Regardless, of the power control framework, P2P transmitter and receiver may of course need to follow certain reporting procedures in order to provide channel state and channel quality feedback for link maintenance, as discussed below.

Tx-PSD and pathloss compensation based power control. In case of these transmit power based power control frameworks, it seems natural that P2P transmitters broadcast their Tx-PSD level, while receivers perform the utility computation by extrapolating the additional interference caused by neighboring P2P transmitters.

IoT-projection based power control. In case of IoT-projection, it seems natural that receivers broadcast their desired IoT targets which neighboring P2P transmitters use to adjust their open-loop projection based Tx-PSD. P2P transmitters of neighboring links may, in this case, perform the utility computation based on extrapolating their Tx-PSD conditioned on changes in the IoT targets of a neighboring link. As mentioned above, P2P transmitter and receiver may facilitate accurate rate prediction by exchanging channel state and channel quality information.

The power control frameworks mentioned above have in common that P2P transmitter/receiver forecast changes in system performance based on changes in the transmit power or interference level of its own or neighboring links. However, in addition, other factors may be incorporated into the utility metric, for example, quality-of-service (QoS) factors, packet delay information, and many more. If such metrics are not known at both P2P transmitter and receiver, some metrics may need to be exchanged between P2P transmitter and receiver to facilitate this operation. For example, if some packet delay metric may only be known at the P2P transmitter, but is needed at the receiver for utility computation, then some information may have to be exchanged. It seems natural to assume that such metrics will not change at a faster pace than the actual resource partitioning messaging and thus such factors may be incorporated by exchanging such metrics between transmitter and receiver of the same P2P link.

Interaction with the WAN

In the presence of a WAN, some of the traffic destined between two P2P devices may be relayed through the WAN if, for some reason, direct P2P communication is not desired. In this configuration, the P2P transmissions to the WAN may therefore take place on the same resource as other P2P direct transmissions. Consequently, it is necessary for the WAN to partake in the resource coordination process, similar to the way a receiving P2P device does. However, there are differences that stem from the fact that the WAN is associated with more than a single P2P transmitter and therefore has to perform scheduling and other functions associated with the WAN. Also, the WAN needs to be able to support “cloud” traffic that is not destined for any UE in the local coverage of the WAN.

A way to incorporate the necessary WAN interaction into the resource coordination framework presented in this contribution, is to have WAN-UEs report power control levels and path loss information of its neighbors to the WAN which then performs the necessary computations and may thus take WAN-specific requirements on maximum Tx-PSD levels and scheduling restrictions into account. The utility metric and any other information that need to be exchanged with neighboring nodes may be communicated back to the WAN-UE which signals it to neighboring links. It should be noted that other ways of signaling this information may be considered and are transparent to the operation of the algorithm. For example, the WAN may directly communicate the information to the WAN-UEs.

### Signaling Messages in Support of Resource Coordination

The signaling in support of the resource partitioning procedure described in this algorithm has been discussed herein. For increased clarity, however, we provide a timeline of the message exchanges that may take place in one embodiment of this concept. As stated before, the operation of the algorithm may be supported by various types of messages exchanges and the descriptions below should only be viewed as example embodiments of this concept.

The actual transmission of the messages described in this disclosure may take place in various ways. For example, all signaling may occur over-the-air or alternatively some or all may be relayed between devices through the WAN. In case of an over-the-air design, the broadcast of the current activity level of a P2P link may take place periodically in designated subframes. The negotiation messages between P2P aggressors and victims may also be transmitted in a broadcast fashion, even though some of the payload of these messages may be unicast in nature. In case of WAN-assisted signaling, the messages may be relayed through the WAN. Finally, a mixed design may also be envisioned, relying on a broadcast of the current activity level over-the-air, but relaying of the unicast negotiation messages through the WAN. Finally, signaling originating from the WAN may generally take place on the downlink, since eNBs typically don't have uplink transmitters.

In general, as described earlier, the signaling relies on periodically broadcasting the current activity level of each P2P link in order to make the current partitioning state known to neighboring links. In between such broadcast messages, each P2P link separately signals its utility conditioned on a certain action taken by each of its neighboring P2P links. By summing over the utility messages received from other P2P links, and by factoring in its own utility associated with a certain action, each P2P link determines the aggregate utility of its neighborhood and determines the most favorable action from this perspective. The resulting action is taken and broadcast, which concludes one period of the resource partitioning procedure.

### Signaling Timeline for Tx-PSD Based Power Control Schemes

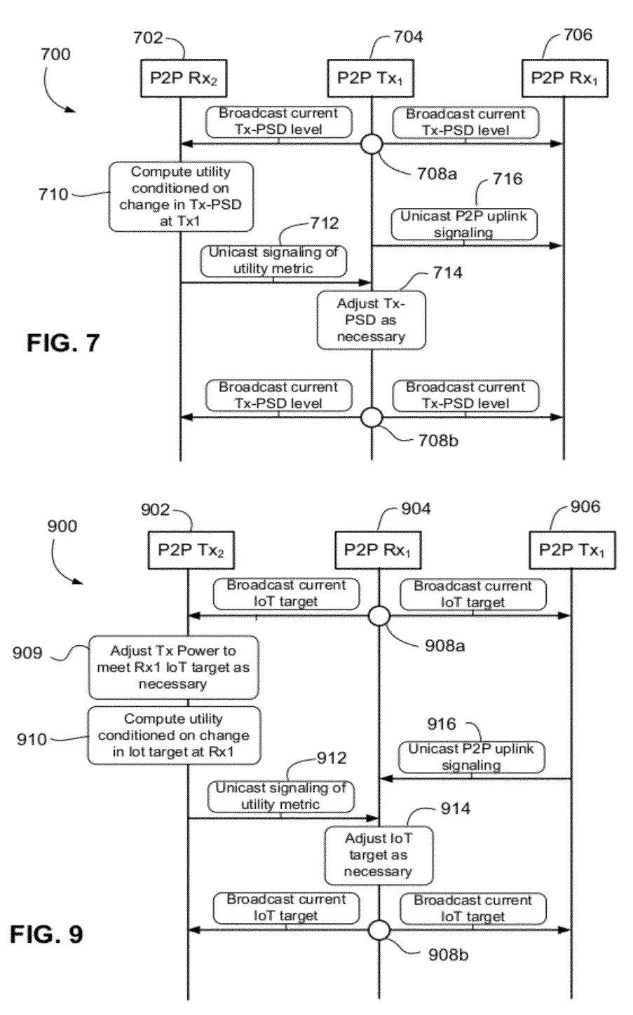

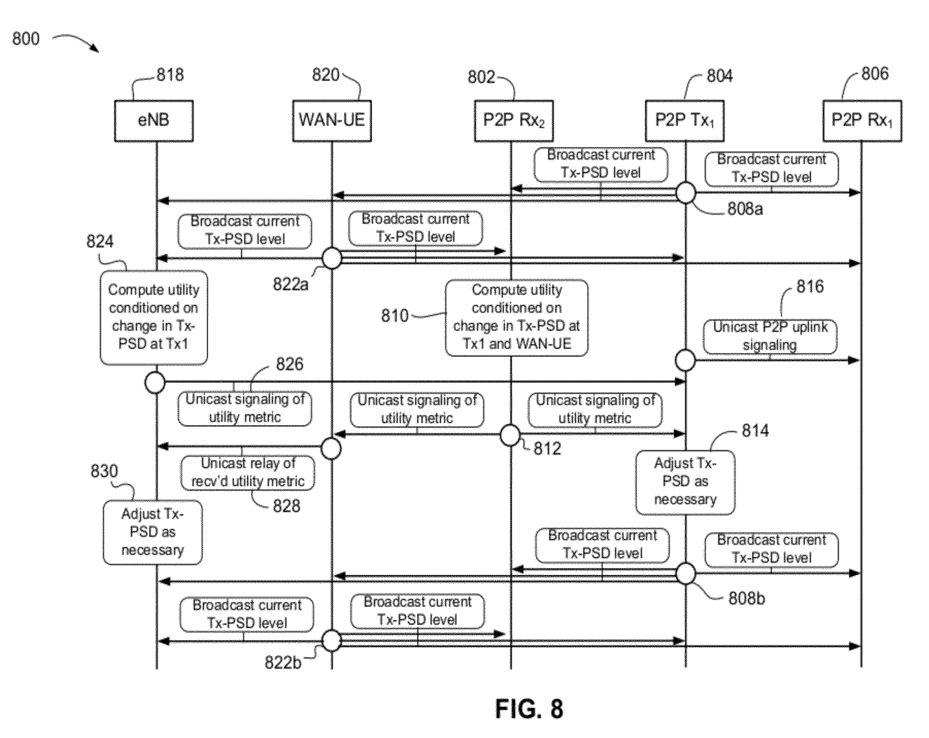

FIG. 7 shows an example of a P2P resource coordination sequence 700 using aggregate neighborhood utility metrics based on activity level indicators from transmitting nodes of neighboring P2P links. FIG. 8 shows an example of the P2P resource coordination sequence shown in FIG. 7, including additional activity at an eNB and a UE not participating in a P2P link. FIGS. 7 and 8 show one embodiments of the signaling timeline under the assumption of Tx-PSD based or pathloss compensation based power control. Although the discussion refers to Tx-PSD information in specific places, it should be appreciated that pathloss compensation information may be used instead of, or in addition to, Tx-PSD information. P2P transmitters and WAN-UEs (in case of WAN presence) broadcast their current Tx-PSD level to make other P2P nodes aware of the current resource partitioning state. P2P receivers and the eNB receive these messages, and use this information to project their own utility conditioned on increases/decreases in the Tx-PSD level.

The utility values obtained by extrapolating link performance conditioned on a one-step change in the Tx-PSD of neighboring links are exchanged and are used by the P2P transmitters to determine whether a change in Tx-PSD is warranted from the perspective of aggregate utility in the neighborhood of the link. To do so, it also factors in the change of its own performance. In the presence of the WAN, WAN-UEs relay the received utility messages to the eNB which performs this optimization process as it needs to factor in the performance of other WAN-UEs in its coverage. The decision of the eNB is communicated to WAN-UEs which broadcast the corresponding Tx-PSD level to inform neighboring P2P transmitters of the decision. P2P transmitters likewise broadcast the Tx-PSD levels, thereby concluding one period of the resource partitioning procedure.

Referring to FIG. 7, an example of a sequence 700 involves a receiving mobile entity node 706 and a transmitting mobile entity node 704 of a first P2P link, and a receiving mobile entity node 702 of a second P2P link in a radio neighborhood of the first link. It should be appreciated that a sequence may include additional receiving nodes for other P2P links in the neighborhood of node 704. A resource partitioning cycle may begin with the transmitter of the first link 704 broadcasting a current transmission PSD level 708a, which is received by any mobile entity within radio range including node 702. In response, the receiving node 702 may compute a relative or absolute utility metric conditioned on a change in Tx-PSD at the transmitting node 704 of the first link.

The first P2P link may be active at various times during the cycle, or in between cycles, for example by node 704 transmitting unicast P2P uplink signaling 716 to a receiving node 706 of the first P2P link. Such transmissions 716 are not part of resource partitioning, but are depicted as an end-use activity supported by resource partitioning. It should be appreciated that these and other activities by one or more of the depicted mobile entities not related to resource partitioning may be performed at any suitable time.

After computing the utility metric 710, the receiving node 702 may provide the utility metric 712 in unicast signaling to the transmitting node 704. In response, the transmitting node 704 may adjust its Tx-PSD used for P2P transmissions 716 so as to maximize an aggregate utility of all P2P links for which it receives utility metric information. The second resource allocation cycle may be initiated by another broadcast of Tx-PSD level 708b by the transmitting node 704, and the cycle repeated.

Referring to FIG. 8, an example of a sequence 800 involves a receiving mobile entity node 806 and a transmitting mobile entity node 804 of a first P2P link, and a receiving mobile entity node 802 of a second P2P link in a radio neighborhood of the first link; and in addition, a WAN-UE mobile entity node 820 that is not participating in any P2P link in the radio neighborhood of the P2P links, and an eNB 818 servicing at least the WAN-UE 820. It should be appreciated that a sequence may include additional receiving nodes for other P2P links in the neighborhood of node 804. A resource partitioning cycle may begin with the transmitter of the first link 804 broadcasting a current transmission PSD level 808a, which is received by any entity within radio range including nodes 802 and 818. In addition, the WAN-UE 820 broadcasts its current transmission PSD level 822a, which is received by any entity within radio range including node 802. In response, the receiving node 802 may compute a relative or absolute utility metric conditioned on a change in Tx-PSD at the transmitting node 804 of the first link and the WAN-UE 820. In addition, the eNB 818 may compute a relative or absolute utility metric 824 conditioned on a change in Tx-PSD at the transmitting node 804 of the first link.

The first P2P link may be active at various times during the cycle, or in between cycles, for example by node 804 transmitting unicast P2P uplink signaling 816 to a receiving node 806 of the first P2P link. Such transmissions 816 are not part of resource partitioning, but are depicted as an end-use activity supported by resource partitioning. It should be appreciated that these and other activities by one or more of the depicted mobile entities not related to resource partitioning may be performed at any suitable time.

After computing the utility metric 824, the eNB 818 may provide the utility metric 826 in unicast signaling to the transmitting node 804. In addition, after computing its utility metric 810, the receiving node 802 may provide the utility metric 812 in unicast signaling to the transmitting node 804 and to the WAN-UE 820. The WAN-UE 820 may relay the utility metric from node 802 to the eNB 818.

In response to receiving the utility metrics, the transmitting node 804 may adjust its Tx-PSD used for P2P transmissions 814 to so as to maximize an aggregate utility of all P2P links for which it receives utility metric information. Likewise, the eNB 818 may adjust 830 its Tx-PSD used for transmissions with the WAN-UE 820. A second resource allocation cycle may be initiated by second broadcasts of Tx-PSD level 808b, 822b by the transmitting node 804 and WAN-UE 820, respectively, and the cycle repeated.

### Signaling Timeline for IoT-Projection Based Power Control Schemes

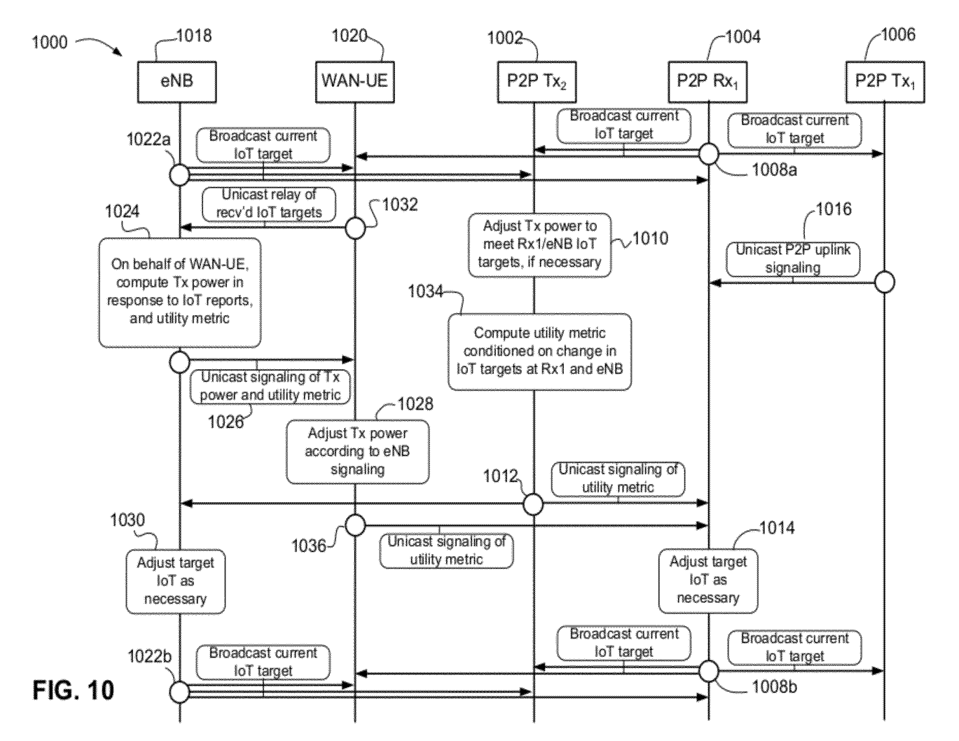

FIG. 9 shows an example of a P2P resource coordination procedure using aggregate neighborhood utility metrics based on activity level indicators from receiving nodes of neighboring P2P links FIG. 10 shows an example of the P2P resource coordination sequence shown in FIG. 9, including additional activity at an eNB and a UE not participating in a P2P link. The FIGS. 9 and 10 are based on an assumption that IoT-projection based power control, or some equivalent power control scheme, has been adopted as the underlying power control framework of the algorithm. Therefore, IoT targets are being negotiated as part of the resource coordination procedure.

As shown in FIGS. 9 and 10, P2P receivers and the eNB (in case of WAN presence) broadcast their current desired IoT targets to make other nodes aware of the latest power control setting they have chosen. P2P transmitters and WAN-UEs receive these messages, and WAN-UEs further relay this information on to the eNB since for WAN-UEs the WAN may perform the necessary calculations described later on. If the broadcast IoT target has changed compared to the one that was previously advertised, the transmit power of the P2P transmitters or the WAN-UEs may need to be adjusted accordingly. The P2P transmitters may do so autonomously whereas the WAN-UEs rely on relaying the information to the WAN and receiving appropriate control information by the eNB to this effect.

Based on the most recent IoT target setting, P2P transmitters and the eNB on behalf of WAN-UEs compute the utility conditioned on changes of the IoT targets of each of its P2P receivers in the neighborhood. Changes of the IoT target in either direction are considered, unless the minimum or maximum IoT target has been reached. The utility values thus obtained are exchanged as described herein and are used by the P2P receivers and the eNB to compute whether or not a change in IoT target is warranted. If so, the IoT value is adjusted. Finally, the IoT target is broadcast, regardless of whether it has changed, and the procedure described in the above paragraphs is repeated.

Referring to FIG. 9, an example of a sequence 900 involves a receiving mobile entity node 904 and a transmitting mobile entity node 906 of a first P2P link, and a transmitting mobile entity node 902 of a second P2P link in a radio neighborhood of the first link. It should be appreciated that a sequence may include additional transmitting nodes for other P2P links in the neighborhood of node 906. A resource partitioning cycle may begin with the receiver of the first link 906 broadcasting a current IoT target level 908a, which is received by any mobile entity within radio range including node 902. If necessary, the transmitting node 902 may adjust its transmitting power 909 in accordance with the current IoT target level. In addition, the transmitting node 902 may compute a relative or absolute utility metric 910 conditioned on a change in the IoT target by the receiving node 904 of the first link, in response to receiving the IoT target.

The first P2P link may be active at various times during the cycle, or in between cycles, for example by node 906 transmitting unicast P2P uplink signaling 916 to a receiving node 904 of the first P2P link. Such transmissions 916 are not part of resource partitioning, but are depicted as an end-use activity supported by resource partitioning. It should be appreciated that these and other activities by one or more of the depicted mobile entities not related to resource partitioning may be performed at any suitable time.

After computing the utility metric 910, the receiving node 902 may provide the utility metric 912 in unicast signaling to the receiving node 904. In response, the receiving node 904 may adjust its IoT target used for P2P transmissions 914 to so as to maximize an aggregate utility of all P2P links for which it receives utility metric information. A following resource allocation cycle may be initiated by another broadcast of IoT target level 908b by the receiving node 904, and the cycle repeated.

Referring to FIG. 10, an example of a sequence 1000 involves a transmitting mobile entity node 1006 and a receiving mobile entity node 1004 of a first P2P link, and a transmitting mobile entity node 1002 of a second P2P link in a radio neighborhood of the first link; and in addition, a WAN-UE mobile entity node 1020 that is not participating in any P2P link in the radio neighborhood, and an eNB 1018 servicing at least the WAN-UE 1020. It should be appreciated that a sequence may include additional receiving nodes for other P2P links in the neighborhood of node 1004. A resource partitioning cycle may begin with the receiving node 1004 of the first link broadcasting a current IoT target level 1008a, which is received by any entity within radio range including nodes 1002 and 1018. In addition, the eNB 1018 broadcasts its current IoT target level 1022a, which is received by any entity within radio range including nodes 1020 and 1002. The WAN-UE 1020 may relay a received IoT target from node 1004 to the eNB 1018.

In response to received IoT targets, the transmitting node 1002 may adjust transmitting power 1010 to meet node 1004 or 1018 IoT targets, if necessary. In addition, the transmitting node 1002 may compute a relative or absolute utility metric 1034 conditioned on a change in IoT target by the receiving node 1004 of the first link and the eNB 1018. The eNB 1018 may also compute a relative or absolute utility metric 1024 conditioned on a change in IoT targets at the receiving node 1004 of the first link, and its own IoT target for WAN-UE 1020.

The first P2P link may be active at various times during the cycle, or in between cycles, for example by node 1006 transmitting unicast P2P uplink signaling 1016 to a receiving node 1004 of the first P2P link. Such transmissions 1016 are not part of resource partitioning, but are depicted as an end-use activity supported by resource partitioning. It should be appreciated that these and other activities by one or more of the depicted mobile entities not related to resource partitioning may be performed at any suitable time.

After computing the utility metric 1024, the eNB 1018 may provide the utility metric 1026 in unicast signaling to the WAN-UE 1020. The WAN-UE 1020 may adjust is transmission power 1028 in accordance with IoT targets from the eNB 1018. In addition, after computing its utility metric 1034, the transmitting node 1002 may provide the utility metric 1012 in unicast signaling to the receiving node 1004 and to the eNB 1018. The WAN-UE may relay 1036 the utility metric from the eNB 1018 to the receiving node 1004.

In response to receiving the utility metrics, the receiving node 1004 may adjust its IoT target used for P2P transmissions 1014 to so as to maximize an aggregate utility of all P2P links for which it receives utility metric information. Likewise, the eNB 1018 may adjust 1030 its IoT target used for transmissions with the WAN-UE 1020. A second resource allocation cycle may be initiated by second broadcasts of Tx-PSD level 1008b, 1022b by the receiving node 1004 and WAN-UE 1020, respectively, and the cycle repeated.

### Methodology & Apparatus Examples Pertaining to Resource Coordination for Mobile Entities Using Aggregate Neighborhood Utility Metrics

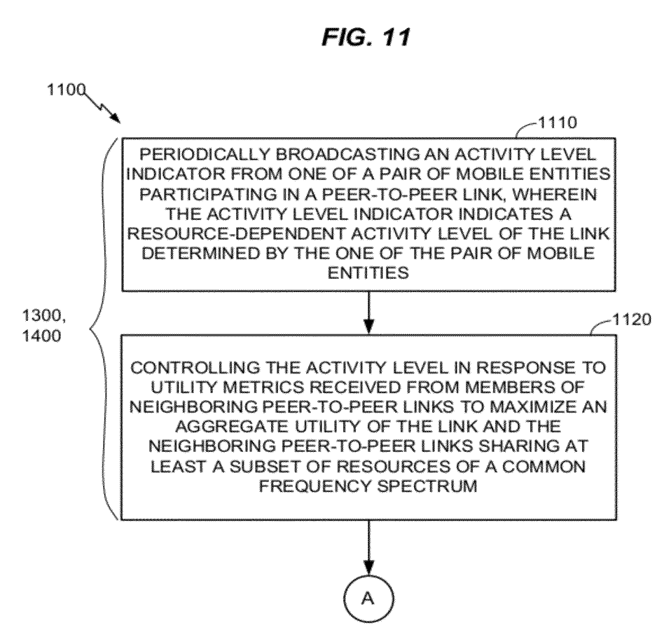

In view of exemplary systems shown and described in the foregoing sections, methodologies that may be implemented in accordance with the disclosed subject matter, will be better appreciated with reference to various flow charts. For purposes of simplicity of explanation, methodologies are shown and described as a series of acts/blocks. It should be apparent that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture such as a non-transitory computer-readable medium to facilitate transporting and transferring such methodologies to various devices, or implementing a methodology using a particular processing device. Those skilled in the art will understand and appreciate that a methodology may alternatively be represented as a series of interrelated states or events, such as in a state diagram. FIG. 11 illustrates an example of a P2P resource coordination method 1100 using aggregate neighborhood utility metrics for performance by a node of a P2P link that periodically broadcasts an activity level indicator. The method 1100 may be performed at a wireless communication apparatus, for example a mobile entity such as a UE. The method 1100 may comprise, at 1110, periodically broadcasting an activity level indicator from one of a pair of mobile entities participating in a peer-to-peer link, wherein the activity level indicator indicates a resource-dependent activity level of the link determined by the one of the pair of mobile entities. The method 1100 may further comprise, at 1120, controlling the activity level in response to utility metrics received from members of neighboring peer-to-peer links to maximize an aggregate utility of the link and the neighboring peer-to-peer links sharing at least a subset of resources of a common frequency spectrum.

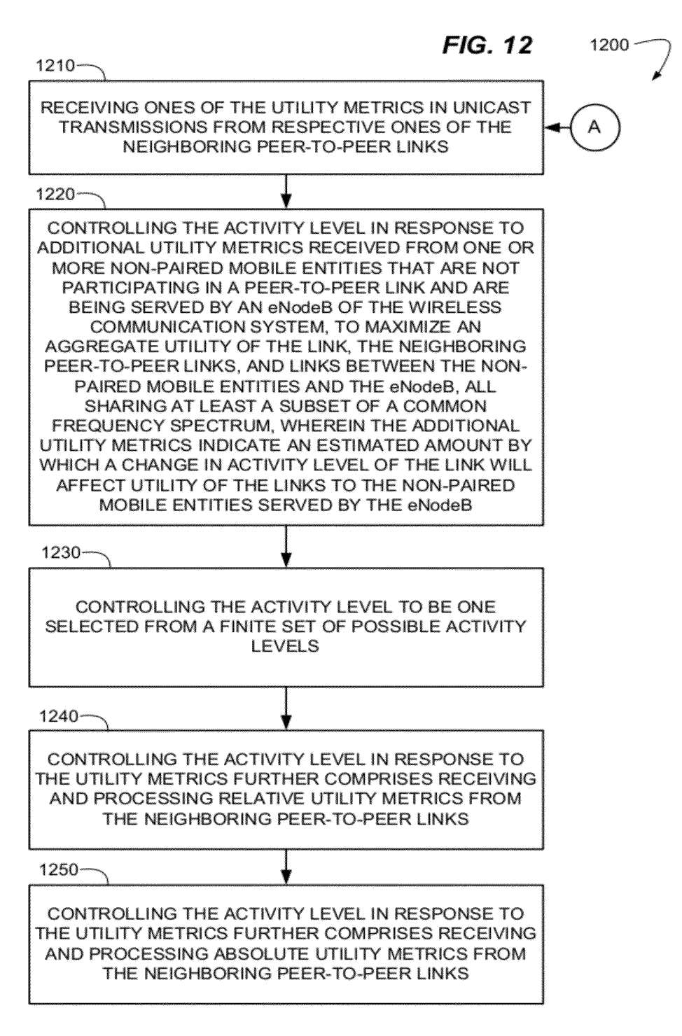

Further optional operations 1200 that may be performed in conjunction with the method 1100 are shown in FIG. 12. The additional operations 1200 may comprise, at 1210, receiving ones of the utility metrics in unicast transmissions from respective ones of the neighboring peer-to-peer links. In the alternative, as noted above, utility metrics may be communicated using methods other than unicast transmissions.

The additional operations 1200 may comprise, at 1220, controlling the activity level in response to additional utility metrics received from one or more non-paired mobile entities that are not participating in a peer-to-peer link and are being served by an eNB of the wireless communication system, to maximize an aggregate utility of the link, the neighboring peer-to-peer links, and links between the non-paired mobile entities and the eNB, all sharing at least a subset of a common frequency spectrum, wherein the additional utility metrics indicate an estimated amount by which a change in activity level of the link will affect utility of the links to the non-paired mobile entities served by the eNB. These operations may be included when one or more mobile entities not participating in a P2P link are present in the radio neighborhood.

The additional operations 1200 may comprise, at 1230, controlling the activity level to be one selected from a finite set of possible activity levels. The use of a finite set of possible activity levels is, as noted above, an important characteristic for practical implementation. The additional operations 1200 may comprise, at 1240, controlling the activity level in response to the utility metrics further comprising receiving and processing relative utility metrics from the neighboring peer-to-peer links. In the alternative, or in addition, the additional operations 1200 may comprise, at 1250, controlling the activity level in response to the utility metrics further comprising receiving and processing absolute utility metrics from the neighboring peer-to-peer links. Relative and absolute utility metrics should be understood as defined herein above.

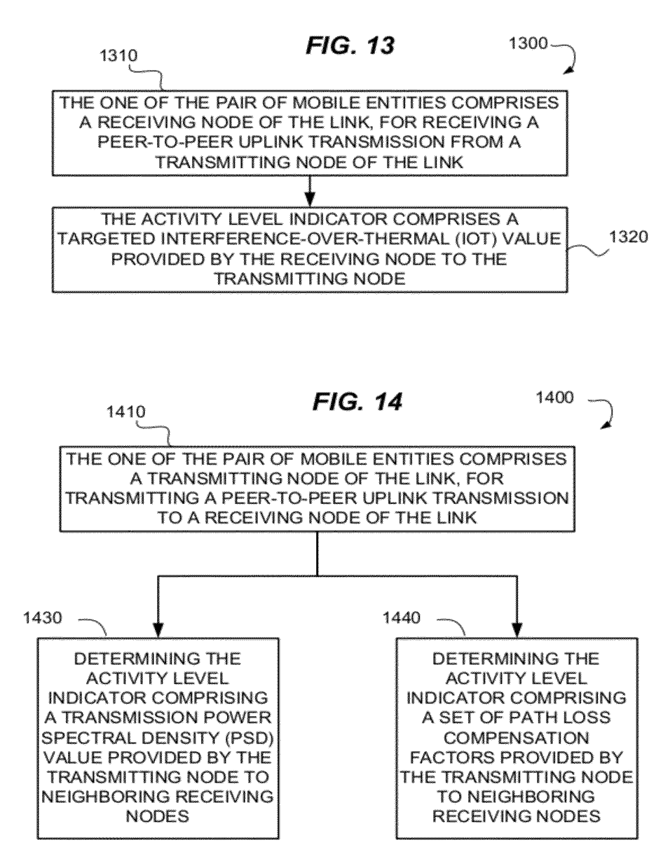

In an embodiment 1300 depicted in FIG. 13, the method 1100 may be characterized by, at 1310, the one of the pair of mobile entities comprising a receiving node of the link for receiving a peer-to-peer transmission from a transmitting node of the link. In such case, as indicated at 1320, method 1100 may further comprise determining the activity level indicator comprising a targeted IoT value provided by the receiving node to neighboring transmitting nodes.

In alternative embodiments 1400 depicted in FIG. 14, the method 1100 may be characterized by, at 1410, the one of the pair of mobile entities comprising a transmitting node of the link for transmitting a peer-to-peer transmission to a receiving node of the link. In such case, as indicated at 1430, method 1100 may further comprise determining the activity level indicator comprising a Tx-PSD value provided by the transmitting node to neighboring receiving nodes. In the alternative, as indicated at 1440, the method 1100 may further comprise determining the activity level indicator comprising a set of path loss compensation factors provided by the transmitting node to neighboring receiving nodes, including to the receiving node.

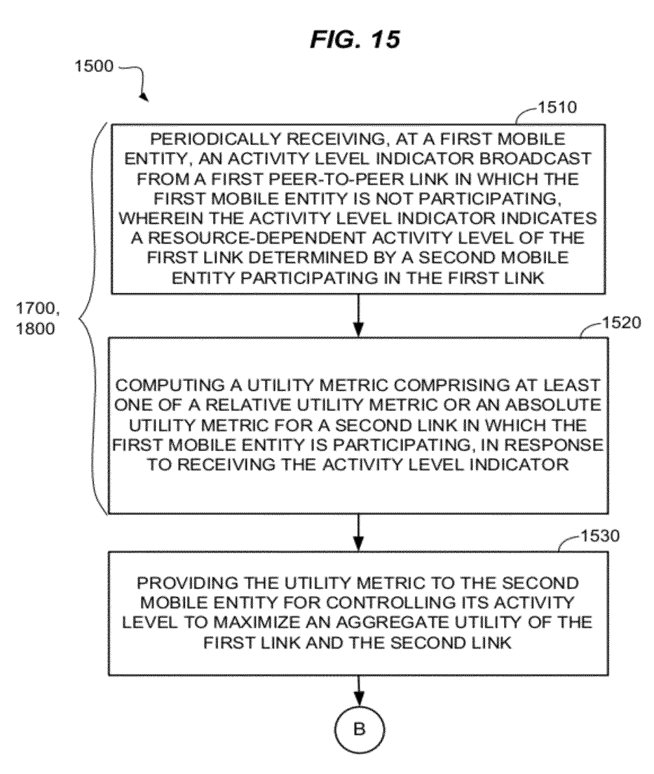

FIG. 15 illustrates an example of a P2P resource coordination method 1500 using aggregate neighborhood utility metrics for performance by a node of a P2P link that periodically receives an activity level indicator broadcast from a different P2P link. The method 1500 may be performed at a wireless communication apparatus, for example a mobile entity such as a UE. The method 1500 may comprise, at 1510, periodically receiving, at a first mobile entity, an activity level indicator broadcast from a first peer-to-peer link in which the first mobile entity is not participating, wherein the activity level indicator indicates a resource-dependent activity level of the first link determined by a second mobile entity participating in the first link. The method 1500 may further comprise, at 1520, computing a utility metric comprising at least one of a relative utility metric or an absolute utility metric for a second link in which the first mobile entity is participating, in response to receiving the activity level indicator. The method 1500 may further comprise, at 1530, providing the utility metric to the second mobile entity for controlling its activity level to maximize an aggregate utility of the first link and the second link.

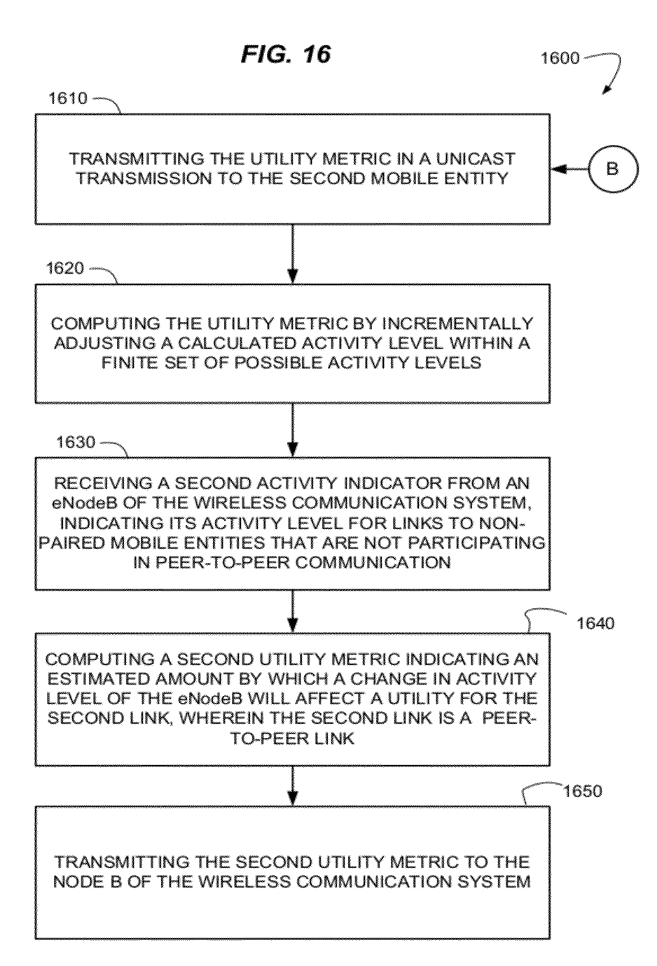

Further optional operations 1600 that may be performed by the first mobile entity in conjunction with the method 1500 are shown in FIG. 16. The additional operations 1200 may comprise, at 1610, transmitting the utility metric in a unicast transmission to the second mobile entity. In the alternative, as noted above, utility metrics may be communicated using methods other than unicast transmissions.

The additional operations 1600 may comprise, at 1620, computing the utility metric by incrementally adjusting a calculated activity level within a finite set of possible activity levels. The use of a finite set of possible activity levels is, as noted above, an important characteristic for practical implementation. The additional operations 1600 may comprise, at 1630, receiving a second activity indicator from an eNB of the wireless communication system, indicating its activity level for links to non-paired mobile entities that are not participating in peer-to-peer communication. The additional operations 1600 may comprise, at 1640, computing a second utility metric indicating an estimated amount by which a change in activity level of the eNB will affect a utility for the second link, wherein the second link is a peer-to-peer link between the first mobile entity and another mobile device. In an alternative embodiment, the second link may be a non-peer-to-peer link between the first mobile entity and the eNB. Relative and absolute utility metrics should be understood as defined herein above. The additional operations 1600 may comprise, at 1650, transmitting the second utility metric to the eNB of the wireless communication system. Optionally, the eNB may use the second utility metric to maximize an aggregate utility of the second link and a third link. In this scenario, the third link may be a non-P2P link between the eNB and a non-paired mobile entity.

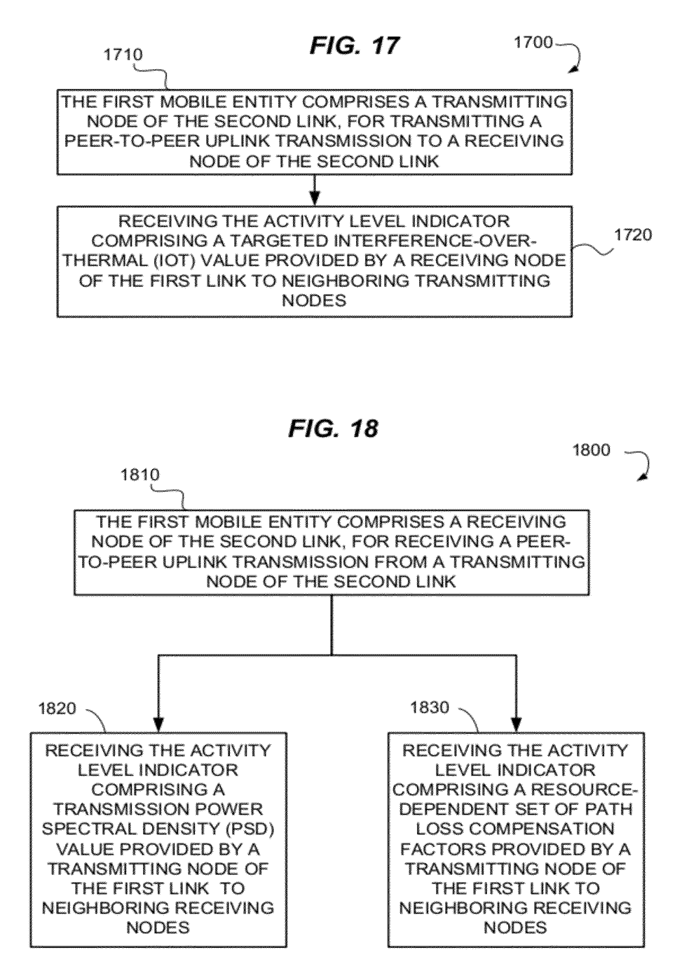

In an embodiment 1700 depicted in FIG. 17, the method 1500 may be characterized by, at 1710, the first mobile entity comprising a transmitting node of the second link, for transmitting a peer-to-peer uplink transmission to a receiving node of the second link. In such case, as indicated at 1720, method 1500 may further comprise determining the activity level indicator comprising a targeted IoT value provided by the receiving node of the first link to neighboring transmitting nodes.

In alternative embodiments 1800 depicted in FIG. 18, the method 1500 may be characterized by, at 1810, the first mobile entity comprising a receiving node of the second link, for receiving a peer-to-peer transmission from a transmitting node of the second link. In such case, as indicated at 1820, method 1500 may further comprise determining the activity level indicator comprising a Tx-PSD value provided by the transmitting node of the first link to neighboring receiving nodes. In the alternative, as indicated at 1830, the method 1500 may further comprise determining the activity level indicator comprising a set of path loss compensation factors provided by the transmitting node of the first link to neighboring receiving nodes.

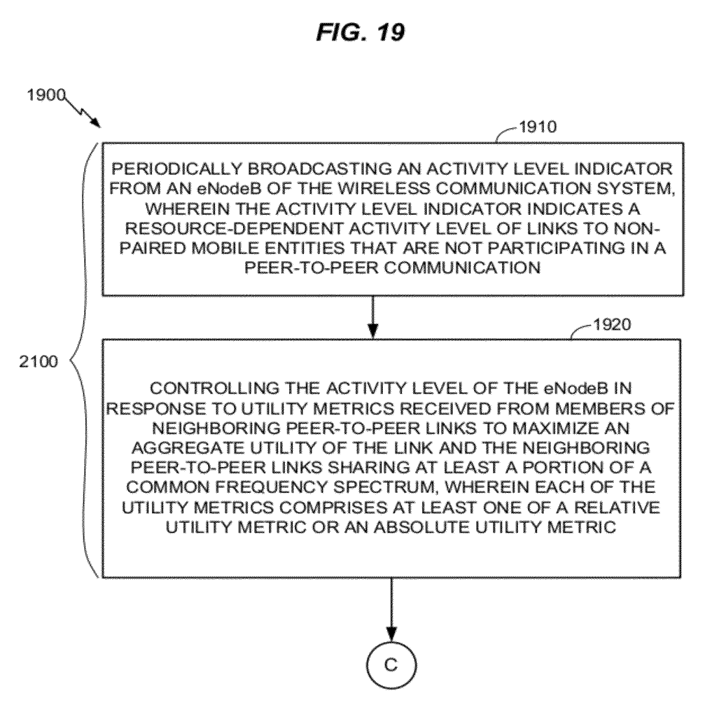

FIG. 19 illustrates an example of a P2P resource coordination method 1900 using aggregate neighborhood utility metrics for performance by an eNB operating in a neighborhood including at least one P2P link. The method 1900 may comprise, at 1910, the eNB periodically broadcasting an activity level indicator from an eNB of the wireless communication system, wherein the activity level indicator indicates a resource-dependent activity level of links to non-paired mobile entities that are not participating in a peer-to-peer communication. The method 1900 may further comprise, at 1920, the eNB controlling the activity level of the eNB in response to utility metrics received from members of neighboring peer-to-peer links to maximize an aggregate utility of the link and the neighboring peer-to-peer links sharing at least a subset of a common frequency spectrum, wherein each of the utility metrics comprises at least one of a relative utility metric or an absolute utility metric.

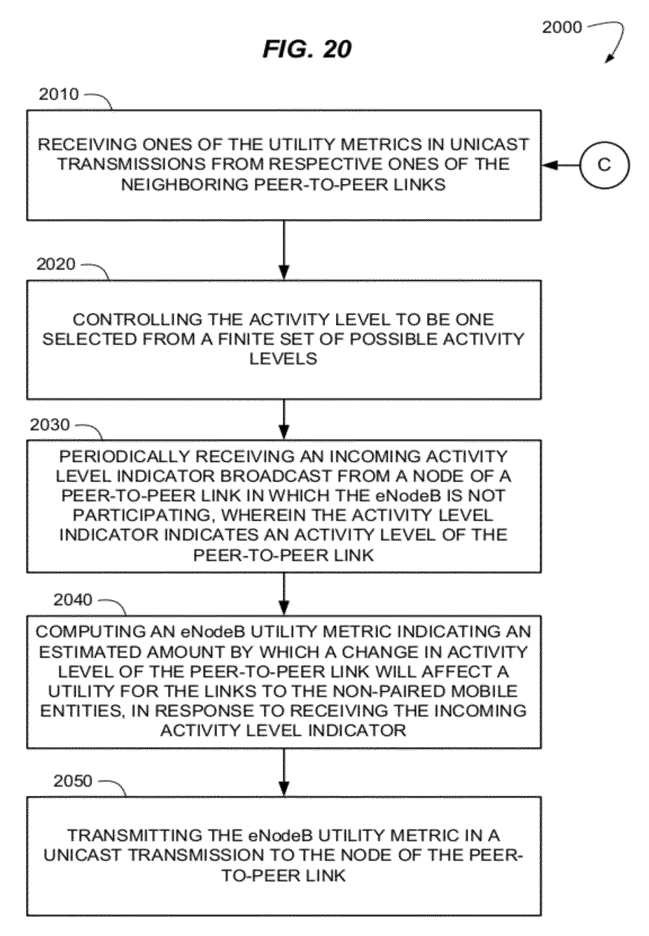

FIG. 20 shows further operations 2000 that may be performed in conjunction with the method 1900. The further operations may comprise, at 2010, receiving ones of the utility metrics in unicast transmissions from respective ones of the neighboring peer-to-peer links. The further operations may comprise, at 2020, controlling the activity level to be one selected from a finite set of possible activity levels. The further operations may comprise, at 2030, periodically receiving an incoming activity level indicator broadcast from a node of a peer-to-peer link in which the eNB is not participating, wherein the activity level indicator indicates an activity level of the peer-to-peer link. The further operations may comprise, at 2040, computing an eNB utility metric indicating an estimated amount by which a change in activity level of the peer-to-peer link will affect a utility for the links to the non-paired mobile entities, in response to receiving the incoming activity level indicator. The further operations may comprise, at 2050, transmitting the eNB utility metric in a unicast transmission to the node of the peer-to-peer link.

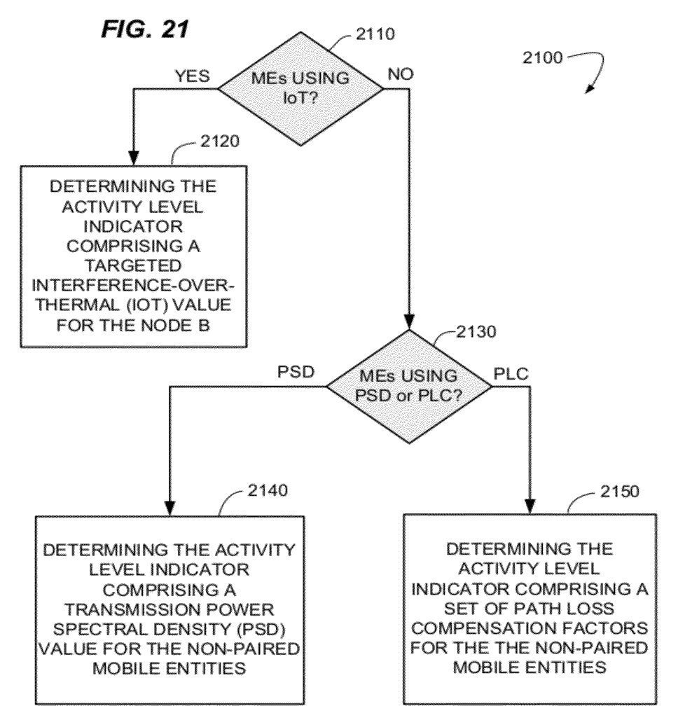

FIG. 21 shows alternative embodiments 2100 of the method 1900. As indicated at 2110, if mobile entities are using IoT for power control, method 1900 may further comprise, at 2120, determining the activity level indicator comprising a targeted interference-over-thermal (IoT) value for the eNB. As indicated at 2130, if mobile entities are using PSD for power control, method 1900 may further comprise, at 2140, determining the activity level indicator comprising a transmission power spectral density (PSD) value for the non-paired mobile entities communicating with the eNB. Conversely, if mobile entities are using path loss compensation factors for power control, method 1900 may further comprise, at 2150, determining the activity level indicator comprising a set of path loss compensation factors for the non-paired mobile entities communicating with the eNB.

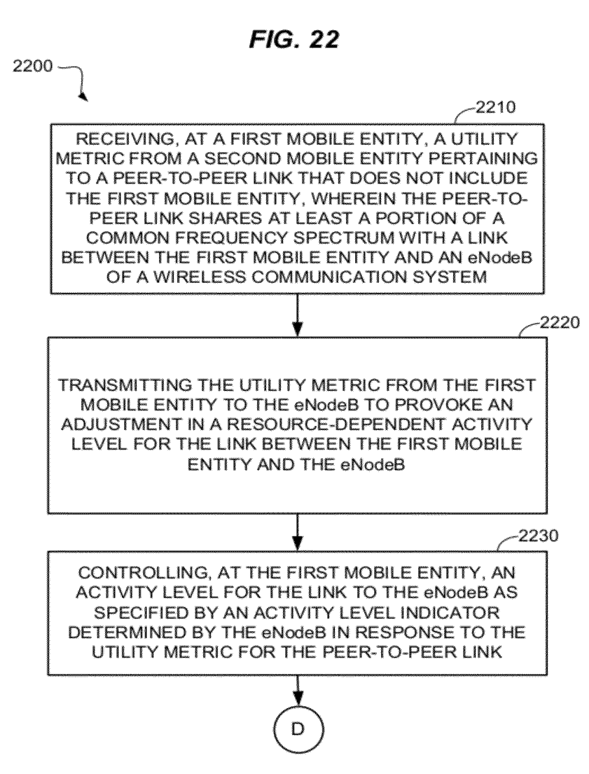

FIG. 22 illustrates an example of a method 2200 supporting P2P resource coordination using aggregate neighborhood utility metrics, for performance by a UE that is not itself participating in a P2P link and receives a utility metric from a neighboring P2P node. The method 2200 may comprise, at 2210, receiving, at a first mobile entity, a utility metric from a second mobile entity pertaining to a peer-to-peer link that does not include the first mobile entity, wherein the peer-to-peer link shares at least a portion of a common frequency spectrum with a link between the first mobile entity and eNB of a wireless communication system. The method 2200 may comprise, at 2220, transmitting the utility metric from the first mobile entity to the eNB to provoke an adjustment in a resource-dependent activity level for the link between the first mobile entity and the eNB. The method 2200 may comprise, at 2230, controlling, at the first mobile entity, an activity level for the link to the eNB as specified by an activity level indicator determined by the eNB in response to the utility metric for the peer-to-peer link.

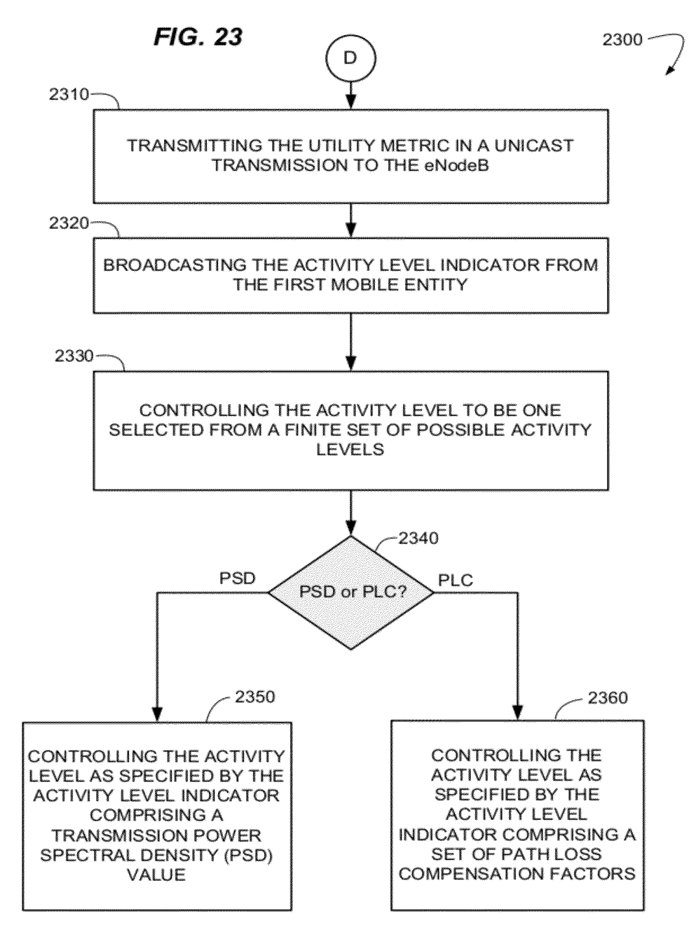

FIG. 23 shows further operations 2300 that may be performed in conjunction with the method 2200. The further operations 2300 may comprise, at 2310, transmitting the utility metric in a unicast transmission to the eNB. The further operations 2300 may comprise, at 2320, broadcasting the activity level indicator from the first mobile entity. The further operations 2300 may comprise, at 2330, controlling the activity level to be one selected from a finite set of possible activity levels. As indicated at 2340, if the system is using PSD for power control, then the further operations may comprise, at 2350, controlling the activity level as specified by the activity level indicator comprising a Tx-PSD value. Conversely, if the system is using path loss compensation factors for power control, the further operation may comprise, at 2360, controlling the activity level as specified by the activity level indicator comprising a set of path loss compensation factors.

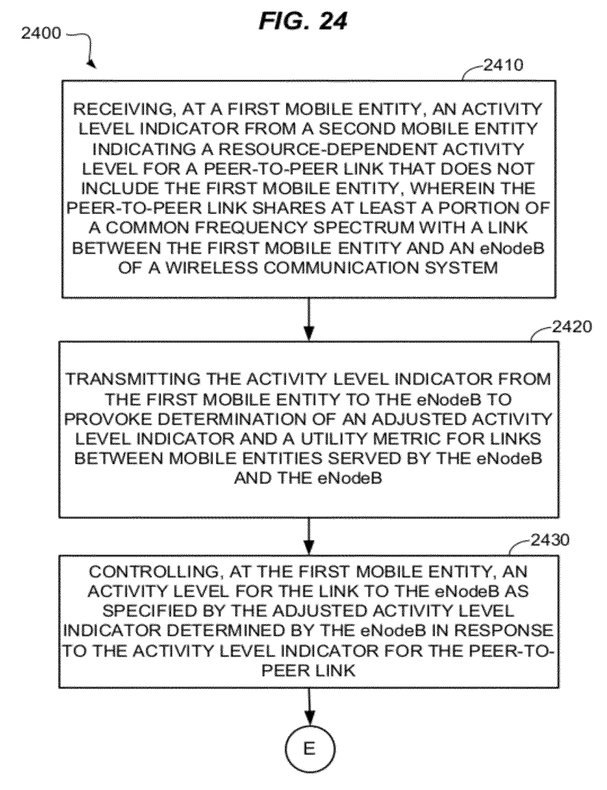

FIG. 24 illustrates an example of a method 2400 supporting P2P resource coordination using aggregate neighborhood utility metrics, for performance by a UE that is not itself participating in a P2P link and receives an activity level indicator from a neighboring P2P node. Method 2400 may be distinguished from method 2300, in that the performing UE receives a utility metric in method 2200 and an activity level indicator in method 2400. Method 2400 may comprise, at 2410, receiving, at a first mobile entity, an activity level indicator from a second mobile entity indicating a resource-dependent activity level for a peer-to-peer link that does not include the first mobile entity, wherein the peer-to-peer link shares at least a portion of a common frequency spectrum with a link between the first mobile entity and eNB of a wireless communication system. Method 2400 may further comprise, at 2420, transmitting the activity level indicator from the first mobile entity to the eNB to provoke determination of an adjusted activity level indicator and a utility metric for the links between non-paired mobile entities served by the eNB. Method 2400 may further comprise, at 2430, controlling, at the first mobile entity, an activity level for the link to the eNB as specified by the adjusted activity level indicator determined by the eNB in response to the activity level indicator for the peer-to-peer link.

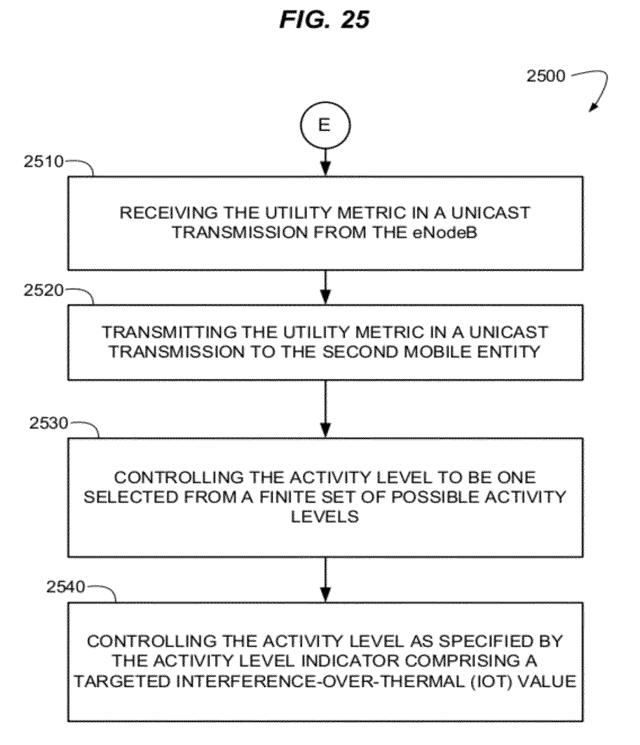

FIG. 25 shows further operations 2500 that may be performed in conjunction with method 2400. The further operations 2500 may comprise, at 2510, receiving the utility metric in a unicast transmission from the eNB. The further operations 2500 may comprise, at 2520, transmitting the utility metric in a unicast transmission to the second mobile entity. The further operations 2500 may comprise, at 2530, controlling the activity level to be one selected from a finite set of possible activity levels. The further operations 2500 may comprise, at 2540, controlling the activity level as specified by the activity level indicator comprising a targeted IoT value.

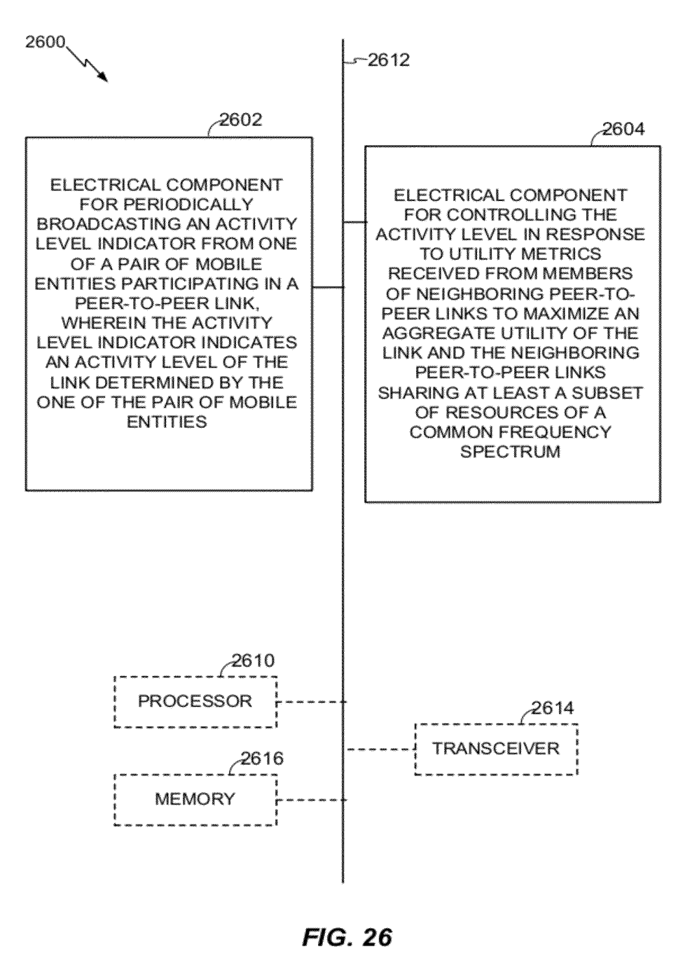

With reference to FIG. 26, there is provided an exemplary apparatus 2600 that may be configured as a mobile entity or UE in a wireless network, or as a processor or similar device for use within the ME or UE, for resource coordination in peer-to-peer communications. The apparatus 2600 may include functional blocks that may represent functions implemented by a processor, software, or combination thereof (e.g., firmware).

As illustrated, in one embodiment, the apparatus 2600 may comprise an electrical component or module 2602 for periodically broadcasting an activity level indicator from one of a pair of mobile entities participating in a peer-to-peer link, wherein the activity level indicator indicates a resource-dependent activity level of the link determined by the one of the pair of mobile entities. For example, the electrical component 2602 may comprise at least one control processor coupled to a transceiver or the like and to a memory with compatible instructions. The component 2602 may be, or may include, a means for periodically broadcasting an activity level indicator from one of a pair of mobile entities participating in a peer-to-peer link, wherein the activity level indicator indicates a resource-dependent activity level of the link determined by the one of the pair of mobile entities. Said means may include the at least one control processor operating an algorithm. The algorithm may include, for example, measuring a resource-dependent activity level of the link using any of the more detailed techniques disclosed herein, or receiving the resource-dependent activity level of the link from the other member of the link. The algorithm may further include, for example, developing an a quantitative indicator of the activity level using a predefined scaling and/or aggregating function, and broadcasting the indicator at periodic times.

The apparatus 2600 may comprise an electrical component 2604 for controlling the activity level in response to utility metrics received from members of neighboring peer-to-peer links to maximize an aggregate utility of the link and the neighboring peer-to-peer links sharing at least a subset of resources of a common frequency spectrum. For example, the electrical component 2604 may comprise at least one control processor coupled to a transceiver or the like and to a memory holding instructions for controlling the activity level in accordance with algorithms presented herein. The component 2604 may be, or may include, a means for controlling the activity level in response to utility metrics received from members of neighboring peer-to-peer links to maximize an aggregate utility of the link and the neighboring peer-to-peer links sharing at least a subset of resources of a common frequency spectrum. Said means may include the at least one control processor operating an algorithm. The algorithm may include, for example, calculating a current utility measure and a projected utility measure based on a projected change in activity level, and implementing the projected activity level in response to determining that the projected utility measure is greater than the current utility measure.

The apparatus 2600 may include similar electrical components for performing any or all of the additional operations 1200, 1300, or 1400 described in connection with FIGS. 12-14, which for illustrative simplicity are not shown in FIG. 26.

In related aspects, the apparatus 2600 may optionally include a processor component 2610 having at least one processor, in the case of the apparatus 2600 configured as a mobile entity. The processor 2610, in such case, may be in operative communication with the components 2602-2604 or similar components via a bus 2612 or similar communication coupling. The processor 2610 may effect initiation and scheduling of the processes or functions performed by electrical components 2602-2604.

In further related aspects, the apparatus 2600 may include a radio transceiver component 2614. A stand alone receiver and/or stand alone transmitter may be used in lieu of or in conjunction with the transceiver 2614. The apparatus 2600 may optionally include a component for storing information, such as, for example, a memory device/component 2616. The computer readable medium or the memory component 2616 may be operatively coupled to the other components of the apparatus 2600 via the bus 2612 or the like. The memory component 2616 may be adapted to store computer readable instructions and data for performing the activity of the components 2602-2604, and subcomponents thereof, or the processor 2610, or the methods disclosed herein. The memory component 2616 may retain instructions for executing functions associated with the components 2602-2604. While shown as being external to the memory 2616, it is to be understood that the components 2602-2604 may exist within the memory 2616.

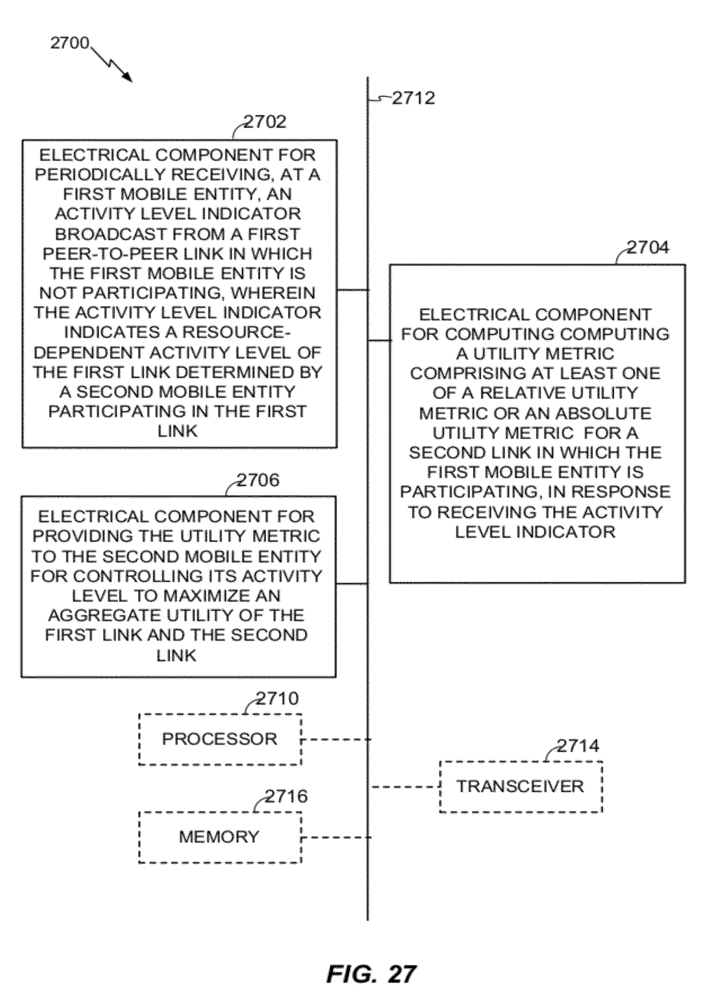

With reference to FIG. 27, there is provided an exemplary apparatus 2700 that may be configured as a mobile entity or UE in a wireless network, or as a processor or similar device for use within the ME or UE, for resource coordination in peer-to-peer communications, according to an alternative embodiment. The apparatus 2700 may include functional blocks that may represent functions implemented by a processor, software, or combination thereof (e.g., firmware).

As illustrated, in one embodiment, the apparatus 2700 may comprise an electrical component or module 2702 for periodically receiving, at a first mobile entity, an activity level indicator broadcast from a first peer-to-peer link in which the first mobile entity is not participating, wherein the activity level indicator indicates a resource-dependent activity level of the first link determined by a second mobile entity participating in the first link. For example, the electrical component 2702 may comprise at least one control processor coupled to a transceiver or the like and to a memory with compatible instructions. The component 2702 may be, or may include, a means for periodically receiving, at a first mobile entity, an activity level indicator broadcast from a first peer-to-peer link in which the first mobile entity is not participating, wherein the activity level indicator indicates a resource-dependent activity level of the first link determined by a second mobile entity participating in the first link. Said means may include the at least one control processor operating an algorithm. The algorithm may include, for example, receiving broadcast transmissions, and processing the broadcast transmissions to identify a mobile entity not in a P2P link with the receiver and an activity level of the P2P link.

The apparatus 2700 may comprise an electrical component 2704 for computing a utility metric comprising at least one of a relative utility metric or an absolute utility metric for a second link in which the first mobile entity is participating, in response to receiving the activity level indicator. For example, the electrical component 2704 may comprise at least one control processor coupled to a memory holding instructions for computing a utility metric in accordance with algorithms presented herein. The component 2704 may be, or may include, a means for computing a utility metric comprising at least one of a relative utility metric or an absolute utility metric for a second link in which the first mobile entity is participating, in response to receiving the activity level indicator. Said means may include the at least one control processor operating an algorithm. The algorithm may include, for example, triggering a computation of a utility metric using any of the more detailed procedures described elsewhere herein, either as an absolute measure or relative to an earlier measure, based on receiving the activity level indicator.

The apparatus 2700 may comprise an electrical component 2706 for providing the utility metric to the second mobile entity for controlling its activity level to maximize an aggregate utility of the first link and the second link. For example, the electrical component 2706 may comprise at least one control processor coupled to a transceiver or the like and to a memory holding compatible instructions. The component 2706 may be, or may include, a means for providing the utility metric to the second mobile entity for controlling its activity level to maximize an aggregate utility of the first link and the second link. Said means may include the at least one control processor operating an algorithm. The algorithm may include, for example, broadcasting the utility metric to the second mobile entity, or unicasting the utility metric to the second mobile entity.

The apparatus 2700 may include similar electrical components for performing any or all of the additional operations 1600, 1700, or 1800 described in connection with FIGS. 16-18, which for illustrative simplicity are not shown in FIG. 27.

In related aspects, the apparatus 2700 may optionally include a processor component 2710 having at least one processor, in the case of the apparatus 2700 configured as a mobile entity. The processor 2710, in such case, may be in operative communication with the components 2702-2706 or similar components via a bus 2712 or similar communication coupling. The processor 2710 may effect initiation and scheduling of the processes or functions performed by electrical components 2702-2706.

In further related aspects, the apparatus 2700 may include a radio transceiver component 2714. A stand alone receiver and/or stand alone transmitter may be used in lieu of or in conjunction with the transceiver 2714. The apparatus 2700 may optionally include a component for storing information, such as, for example, a memory device/component 2716. The computer readable medium or the memory component 2716 may be operatively coupled to the other components of the apparatus 2700 via the bus 2712 or the like. The memory component 2716 may be adapted to store computer readable instructions and data for performing the activity of the components 2702-2706, and subcomponents thereof, or the processor 2710, or the methods disclosed herein. The memory component 2716 may retain instructions for executing functions associated with the components 2702-2706. While shown as being external to the memory 2716, it is to be understood that the components 2702-2706 may exist within the memory 2716.

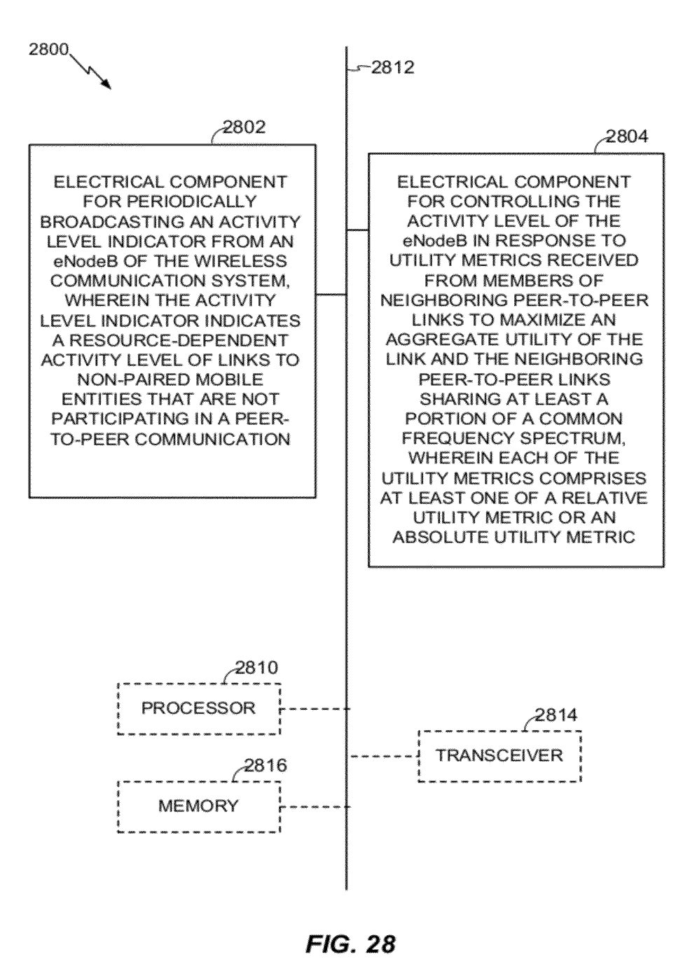

With reference to FIG. 28, there is provided an exemplary apparatus 2800 that may be configured as an eNB (e.g., eNB or HNB) in a wireless network, or as a processor or similar device for use within eNB, for resource coordination related to peer-to-peer communications. The apparatus 2800 may include functional blocks that may represent functions implemented by a processor, software, or combination thereof (e.g., firmware).

As illustrated, in one embodiment, the apparatus 2800 may comprise an electrical component or module 2802 for periodically broadcasting an activity level indicator from an eNB of the wireless communication system, wherein the activity level indicator indicates a resource-dependent activity level of links to non-paired mobile entities that are not participating in a peer-to-peer communication. For example, the electrical component 2802 may comprise at least one control processor coupled to a transceiver or the like and to a memory with compatible instructions. The component 2802 may be, or may include, a means for periodically broadcasting an activity level indicator from an eNB of the wireless communication system, wherein the activity level indicator indicates a resource-dependent activity level of links to non-paired mobile entities that are not participating in a peer-to-peer communication. Said means may include the at least one control processor operating an algorithm. The algorithm may include, for example, periodically determining an activity level indicator indicates a resource-dependent activity level of links to non-paired mobile entities that are not participating in a peer-to-peer communication, based on any suitable indicator as described in more detail elsewhere herein. The algorithm may further include, for example, periodically broadcasting the activity level indicator over a wireless interface.

The apparatus 2800 may comprise an electrical component 2804 for controlling the activity level of the eNB in response to utility metrics received from members of neighboring peer-to-peer links to maximize an aggregate utility of the link and the neighboring peer-to-peer links sharing at least a subset of a common frequency spectrum, wherein each of the utility metrics comprises at least one of a relative utility metric or an absolute utility metric. For example, the electrical component 2804 may comprise at least one control processor coupled to a transceiver or the like and to a memory holding instructions for controlling the activity level in accordance with algorithms presented herein. The component 2804 may be, or may include, a means for controlling the activity level of the eNB in response to utility metrics received from members of neighboring peer-to-peer links to maximize an aggregate utility of the link and the neighboring peer-to-peer links sharing at least a subset of a common frequency spectrum, wherein each of the utility metrics comprises at least one of a relative utility metric or an absolute utility metric. Said means may include the at least one control processor operating an algorithm. The algorithm may include, for example, calculating a current utility measure and a projected utility measure of the link and the neighboring peer-to-peer links sharing at least a subset of a common frequency spectrum based on a projected change in activity level, and implementing the projected activity level in response to determining that the projected utility measure is greater than the current utility measure.

The apparatus 2800 may include similar electrical components for performing any or all of the additional operations 2000 or 2100 described in connection with FIGS. 20-21, which for illustrative simplicity are not shown in FIG. 28.

In related aspects, the apparatus 2800 may optionally include a processor component 2810 having at least one processor, in the case of the apparatus 2800 configured as a mobile entity. The processor 2810, in such case, may be in operative communication with the components 2802-2804 or similar components via a bus 2812 or similar communication coupling. The processor 2810 may effect initiation and scheduling of the processes or functions performed by electrical components 2802-2804.

In further related aspects, the apparatus 2800 may include a radio transceiver component 2814. A stand alone receiver and/or stand alone transmitter may be used in lieu of or in conjunction with the transceiver 2814. The apparatus 2800 may optionally include a component for storing information, such as, for example, a memory device/component 2816. The computer readable medium or the memory component 2816 may be operatively coupled to the other components of the apparatus 2800 via the bus 2812 or the like. The memory component 2816 may be adapted to store computer readable instructions and data for performing the activity of the components 2802-2804, and subcomponents thereof, or the processor 2810, or the methods disclosed herein. The memory component 2816 may retain instructions for executing functions associated with the components 2802-2804. While shown as being external to the memory 2816, it is to be understood that the components 2802-2804 may exist within the memory 2816.

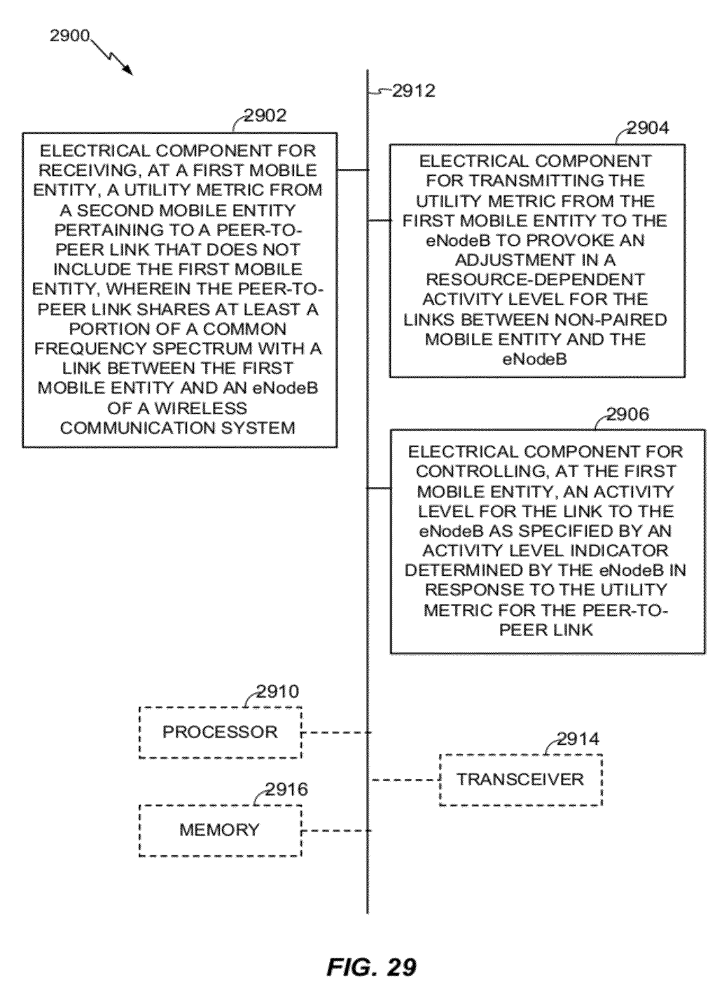

With reference to FIG. 29, there is provided an exemplary apparatus 2900 that may be configured as a mobile entity or UE in a wireless network, or as a processor or similar device for use within the ME or UE, for resource coordination in peer-to-peer communications, according to an alternative embodiment. The apparatus 2900 may include functional blocks that may represent functions implemented by a processor, software, or combination thereof (e.g., firmware).

As illustrated, in one embodiment, the apparatus 2900 may comprise an electrical component or module 2902 for receiving, at a first mobile entity, a utility metric from a second mobile entity pertaining to a peer-to-peer link that does not include the first mobile entity, wherein the peer-to-peer link shares at least a portion of a common frequency spectrum with a link between the first mobile entity and an eNB of a wireless communication system. For example, the electrical component 2902 may comprise at least one control processor coupled to a transceiver or the like and to a memory with compatible instructions. The component 2902 may be, or may include, a means for receiving, at a first mobile entity, a utility metric from a second mobile entity pertaining to a peer-to-peer link that does not include the first mobile entity, wherein the peer-to-peer link shares at least a portion of a common frequency spectrum with a link between the first mobile entity and an eNB of a wireless communication system. Said means may include the at least one control processor operating an algorithm. The algorithm may include, for example, receiving broadcast or unicast transmissions, and processing the broadcast or unicast transmissions to identify a mobile entity not in a P2P link with the receiver and a utility metric for peer-to-peer link that does not include the first mobile entity, wherein the peer-to-peer link shares at least a portion of a common frequency spectrum with a link between the first mobile entity and the eNB.

The apparatus 2900 may comprise an electrical component 2904 for transmitting the utility metric from the first mobile entity to the eNB to provoke an adjustment in a resource-dependent activity level for the link between the first mobile entity and the eNB. For example, the electrical component 2904 may comprise at least one control processor coupled to a transceiver and to a memory holding compatible instructions. The component 2904 may be, or may include, a means for transmitting the utility metric from the first mobile entity to the eNB to provoke an adjustment in a resource-dependent activity level for the link between the first mobile entity and the eNB. Said means may include the at least one control processor operating an algorithm. The algorithm may include, for example, transmitting the utility metric from the first mobile entity with a signal indicating that the eNB should adjust a resource-dependent activity level for the link between the first mobile entity and the eNB.

The apparatus 2900 may comprise an electrical component 2906 for controlling, at the first mobile entity, an activity level for the link to the eNB as specified by an activity level indicator determined by the eNB in response to the utility metric for the peer-to-peer link. For example, the electrical component 2906 may comprise at least one control processor coupled to a memory holding compatible instructions. The component 2906 may be, or may include, a means for controlling, at the first mobile entity, an activity level for the link to the eNB as specified by an activity level indicator determined by the eNB in response to the utility metric for the peer-to-peer link. Said means may include the at least one control processor operating an algorithm. The algorithm may include, for example, receiving an activity level indicator from the eNB, determining that the activity level indicator applies to the link to the eNB, and implementing the activity level for the link.

The apparatus 2900 may include similar electrical components for performing any or all of the additional operations 2300 described in connection with FIG. 23, which for illustrative simplicity are not shown in FIG. 29.

In related aspects, the apparatus 2900 may optionally include a processor component 2910 having at least one processor, in the case of the apparatus 2900 configured as a mobile entity. The processor 2910, in such case, may be in operative communication with the components 2902-2906 or similar components via a bus 2912 or similar communication coupling. The processor 2910 may effect initiation and scheduling of the processes or functions performed by electrical components 2902-2906.

In further related aspects, the apparatus 2900 may include a radio transceiver component 2914. A stand alone receiver and/or stand alone transmitter may be used in lieu of or in conjunction with the transceiver 2914. The apparatus 2900 may optionally include a component for storing information, such as, for example, a memory device/component 2916. The computer readable medium or the memory component 2916 may be operatively coupled to the other components of the apparatus 2900 via the bus 2912 or the like. The memory component 2916 may be adapted to store computer readable instructions and data for performing the activity of the components 2902-2906, and subcomponents thereof, or the processor 2910, or the methods disclosed herein. The memory component 2916 may retain instructions for executing functions associated with the components 2902-2906. While shown as being external to the memory 2916, it is to be understood that the components 2902-2906 may exist within the memory 2916.

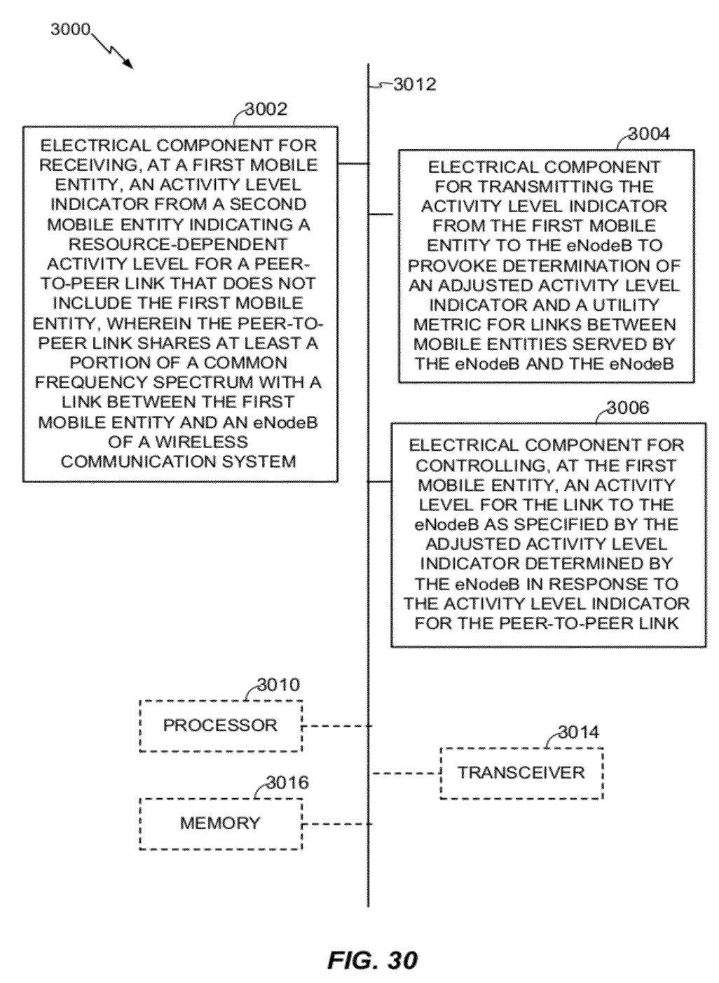

With reference to FIG. 30, there is provided an exemplary apparatus 3000 that may be configured as a mobile entity or UE in a wireless network, or as a processor or similar device for use within the ME or UE, for resource coordination in peer-to-peer communications, according to an alternative embodiment. The apparatus 3000 may include functional blocks that may represent functions implemented by a processor, software, or combination thereof (e.g., firmware).

As illustrated, in one embodiment, the apparatus 3000 may comprise an electrical component or module 3002 for receiving, at a first mobile entity, an activity level indicator from a second mobile entity indicating a resource-dependent activity level for a peer-to-peer link that does not include the first mobile entity, wherein the peer-to-peer link shares at least a portion of a common frequency spectrum with a link between the first mobile entity and an eNB of a wireless communication system. For example, the electrical component 3002 may comprise at least one control processor coupled to a transceiver or the like and to a memory with compatible instructions. The component 3002 may be, or may include, a means for receiving, at a first mobile entity, an activity level indicator from a second mobile entity indicating a resource-dependent activity level for a peer-to-peer link that does not include the first mobile entity, wherein the peer-to-peer link shares at least a portion of a common frequency spectrum with a link between the first mobile entity and an eNB of a wireless communication system. Said means may include the at least one control processor operating an algorithm. The algorithm may include, for example, receiving broadcast or unicast transmissions, and processing the broadcast or unicast transmissions to identify a mobile entity not in a P2P link with the receiver and an activity level for the peer-to-peer link that does not include the first mobile entity, wherein the peer-to-peer link shares at least a portion of a common frequency spectrum with a link between the first mobile entity and an eNB.

The apparatus 3000 may comprise an electrical component 3004 transmitting the activity level indicator from the first mobile entity to the eNB to provoke determination of an adjusted activity level indicator and a utility metric for the links between non-paired mobile entities served by the eNB. For example, the electrical component 3004 may comprise at least one control processor coupled to a transceiver and to a memory holding compatible instructions. The component 3004 may be, or may include, a means for transmitting the activity level indicator from the first mobile entity to the eNB to provoke determination of an adjusted activity level indicator and a utility metric for the links between non-paired mobile entities served by the eNB. Said means may include the at least one control processor operating an algorithm. The algorithm may include, for example, transmitting the utility metric from the first mobile entity with a signal indicating that the eNB should determine an adjusted activity level and a utility metric for the links between non-paired mobile entities served by the eNB.

The apparatus 3000 may comprise an electrical component 3006 for controlling, at the first mobile entity, an activity level for the link to the eNB as specified by the adjusted activity level indicator determined by the eNB in response to the activity level indicator for the peer-to-peer link. For example, the electrical component 3006 may comprise at least one control processor coupled to a memory holding compatible instructions. The component 3006 may be, or may include, a means for controlling, at the first mobile entity, an activity level for the link to the eNB as specified by the adjusted activity level indicator determined by the eNB in response to the activity level indicator for the peer-to-peer link. Said means may include the at least one control processor operating an algorithm. The algorithm may include, for example, receiving an adjusted activity level indicator from the eNB, determining that the adjusted activity level indicator applies to the link to the P2P link, and implementing the activity level for the link.

The apparatus 3000 may include similar electrical components for performing any or all of the additional operations 2500 described in connection with FIG. 25, which for illustrative simplicity are not shown in FIG. 30.

In related aspects, the apparatus 3000 may optionally include a processor component 3010 having at least one processor, in the case of the apparatus 3000 configured as a mobile entity. The processor 3010, in such case, may be in operative communication with the components 3002-3006 or similar components via a bus 3012 or similar communication coupling. The processor 3010 may effect initiation and scheduling of the processes or functions performed by electrical components 3002-3006.

In further related aspects, the apparatus 3000 may include a radio transceiver component 3014. A stand alone receiver and/or stand alone transmitter may be used in lieu of or in conjunction with the transceiver 3014. The apparatus 3000 may optionally include a component for storing information, such as, for example, a memory device/component 3016. The computer readable medium or the memory component 3016 may be operatively coupled to the other components of the apparatus 3000 via the bus 3012 or the like. The memory component 3016 may be adapted to store computer readable instructions and data for performing the activity of the components 3002-3006, and subcomponents thereof, or the processor 3010, or the methods disclosed herein. The memory component 3016 may retain instructions for executing functions associated with the components 3002-3006. While shown as being external to the memory 3016, it is to be understood that the components 3002-3006 may exist within the memory 3016.

In general, the foregoing discloses a P2P resource coordination framework based on maximizing an aggregate utility metric, including general aspects and features as summarized below. Resource coordination changes are taken in steps (up or down) on a finite set of admissible power levels. Aggregate utility metric is maximized by summing utility changes of neighbors and comparing with utility change at a relevant node. The framework accommodates numerous power control frameworks and numerous utility metrics. The utility metric may capture various system performance criteria, for example, fairness considerations among nodes or a minimum rate requirement (e.g., zero utility below the minimum packet format). WAN involvement in the resource coordination process is enabled through reporting observed power control set points and path loss measurements to the WAN. WAN-UEs are signaled utility metrics and power level settings by the WAN, in return.

### Controlling Peer-to-Peer/Wan Association in Entities of a Wireless Communications System

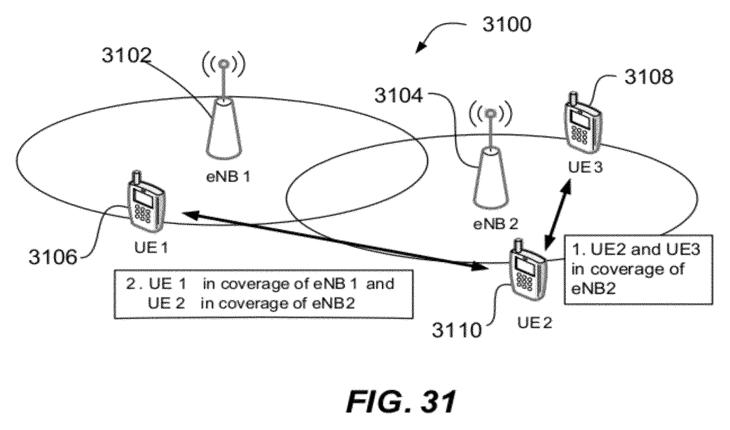

FIG. 31 shows an embodiment of a communication system 3100 comprising mobile entities 3106, 3108, 3110 in communication via eNBs 3102, 3104 of a radio access network (RAN) and via direct wireless connections. The depicted example illustrates peer discovery for (1) UEs 3108, 3110 camped at a cell on the same eNB 3104 and (2) UEs 3106, 3110 camped at cells for respective different eNBs 3102, 3104. Peer discovery is a procedure whereby UEs detect the availability of other services advertised at UEs within radio frequency (RF) proximity, and may generally involve peer advertisement and peer detection.

Peer mobile entities may perform detection, wherein authorized mobile entities may receive information to be able to perform detection (e.g., security keys or the like). Also, the peer mobile entities may perform advertising, wherein authorized mobile entities may receive information to be able to advertise a discovery identifier (e.g., security keys). Each mobile entity refrains from advertising a discovery identifier for which it has not been authorized. Further, the peer mobile entities may perform direct communication, wherein each mobile entity refrains from establishing direct communication with a peer advertising a discovery identifier for which it has not been authorized.

It is noted that a network or spectrum provider may authorize a mobile entity to use the network's spectrum to perform the above described P2P communication procedures. It is also noted that the mobile entity may not be provisioned with P2P parameters and may be expected to request authorization for each procedure or set of procedures. For example, the mobile entity may request authorization for detection, detection and advertising, and/or direct communication. Authorization based on the techniques described herein may be: (a) per tracking area for tracking area update (TAU) procedures; (b) while attached for attach procedures; and/or (c) based on a lifetime of reserved bearers for evolved packet system (EPS) session management (ESM) procedures.

In accordance with one or more aspects of the embodiments described herein, there are provided techniques for making P2P/wide area network (WAN) association decisions based on maximizing aggregate neighborhood utility metrics. The present section of the disclosure pertains to P2P communications between UEs that also have connectivity to a WAN. In this setup, traffic between UEs in proximity of each other may either take place by being relayed through the WAN, or it may occur directly between the two devices. If the communication is relayed through the WAN, we have an uplink transmission to an eNB followed by a subsequent downlink transmission to the designated UE. Resource coordination among the P2P direct communication links and the WAN is performed to mitigate interference.

The instant section of the disclosure pertains particularly to solutions for the problem of how to determine whether proximate UEs should communicate directly or have their traffic relayed through the WAN. Specifically, techniques are provided for making such association decisions based on exchanging utility metrics among neighboring links and the WAN and maximizing an aggregate of these exchanged utilities.

System Architecture: It is assumed that a set of resources in either time, frequency, or some other domain may be assigned to P2P links. Resources are frequently identified with subframes, i.e., time domain interlaces, but the algorithm may also apply to other orthogonal resources. In related aspects, it is possible for the P2P links to avoid direct communication and instead transmit proximate traffic through the WAN. Ultimately, association decisions therefore determine whether or not P2P direct communication should take place. Such a decision may be based on the underlying resource partitioning strategy.

In further related aspects, resources may be assigned to unidirectional communication links between two P2P devices, subject to additional power control constraints on each resource. Unidirectionality refers to the fact that assigning a resource for a link from P2P Device A to P2P Device B may not be available for communication from Device B to Device A. Instead, a separate resource may need to be negotiated for communication from P2P Device B to A. It should be noted, however, that if requirements need to be imposed on what resources are available for communication in either direction, this may be incorporated into the resource coordination technique to perform coordination based on a joint utility metric, incorporating the performance in both directions. For example, this may be the case if a P2P direct connection requires that direct communication takes place in both directions, thus avoiding having one direction perform P2P direct communication while the other is routed through the WAN.

The message exchange between P2P links in support of the resource coordination framework is addressed herein to illustrate the operation of the algorithm. However, the resource coordination technique does not rely on a specific type of message exchange. For example, messages may be transmitter over-the-air or relayed through the WAN, if available.

Measurement Assumptions for the Resource Coordination Algorithm: The resource coordination mechanism described herein assumes that P2P transmitters have knowledge of the (long-term) channel conditions between themselves and neighboring victim P2P receivers, i.e., receiving P2P nodes belonging to a neighboring P2P link. Again, it is noted that since the resource coordination technique addresses unidirectional P2P links, the terms transmitter and receiver are used to refer to a transmitting P2P device and a receiving P2P device, respectively.

In related aspects, the path loss information between the links may be obtained through the transmission of pilot or reference signals. In addition to pilot tones such signals may also transmit identifying information to allow the neighboring P2P nodes to identify which signals may be used to facilitate negotiations with such nodes for resource coordination purposes.

In accordance with one or more aspects of the embodiments described herein, there is provided a utility-based framework for controlling association changes (handovers) between P2P and WAN association. Association determinations pertain to selecting a P2P or mobile-WAN-mobile link for a particular connection between mobile entities, at a particular time. Association changes may also be called “handoffs” or “handovers,” although it should be appreciated that association changes are distinct from traditional handoff or handovers of a mobile link between cellular base stations. Association change refers to novel, non-conventional procedures and, as such, is lacking commonly used terminology in the wireless communications art. Association changes may be dependent on the resource coordination strategy. In short, the resource coordination may rely on the exchange of periodic messages by peers, which carry the utility associated with the increase/decrease of the transmit power level (or equivalently the Interference-over-Thermal (IoT) target of the P2P receiver) of a specific neighboring P2P link by a given step. The information contained in these reports may be used to find the aggregate utility in a neighborhood conditioned on a given device performing such a change, and changes in resource partitioning may be triggered accordingly. Utility messages may be conveyed on a per-resource basis.

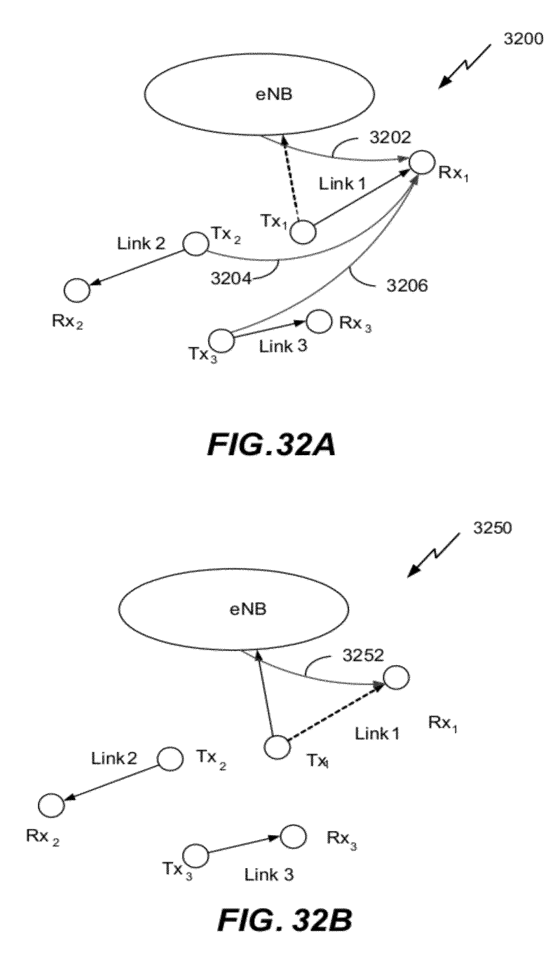

For association decisions, the above-described utility exchanges may be insufficient to determine reliably whether or not a P2P link should perform direct communication or instead relay its traffic through the WAN. Accordingly, the metrics to be exchanged may also depend on whether an association change takes place from P2P operation to the WAN, or vice versa. Both cases are addressed separately below, and FIGS. 32A-B and 33A-B provide an illustrations of example setups.

The P2P direct Link 1 may connect P2P Device Tx1 and P2P Device Rx, wherein Tx1 refers to the P2P transmitter and Rx1 refers to the P2P receiver). There may also be neighboring P2P direct Links 2 and 3, considered to be in P2P direct mode. In the following, we then consider how Link 1's association may change from P2P direct mode to WAN mode, and vice versa.

The resource partitioning framework may work with a variety of different power control frameworks and fundamentally two different types of power control schemes may be differentiated. In a first approach, there are provided transmitter power spectral density (Tx-PSD) based power control schemes that adjust the Tx-PSD at the transmitter, based on a set of admissible values. These admissible values may be specified beforehand, yielding straightforward Tx-PSD set points, or they may be derived from some other metrics. Fractional pathloss compensation schemes are one example of such a scheme. In a second approach, there is provided Interference-over-Thermal (IoT) projection based power control that allows receivers to select IoT targets which are met by neighboring transmitters by adjusting their transmit power.

The resource partitioning procedure is flexible enough to build on both of these power control frameworks and the coordination procedures are substantially similar if links are considered as a single entity. However, if the functions that need to be performed by a link's transmitter and receiver are broken down, their roles may differ depending on the selected framework. Accordingly, such differences will be pointed out when necessary below.

Association change from P2P to WAN association: Changing association from P2P to WAN mode involves weighing the performance advantages/disadvantages of the WAN taking on one more UE (possibly with the benefit of reduced interference) and the neighboring P2P links in the area being able to potentially experience less interference. In order to make informed association decisions, such utility metrics are carefully weighed against each other. For the following signaling exchange it is assumed that the utility messages are received by the P2P link considered for being “broken” and handed-off to the WAN. While it is also possible for the WAN to receive utility messages and make a decision, this may involve increased signaling since the eNB is, in general, not aware of the considered P2P link's neighbors.

In related aspects, utility messages may be exchanged which capture the utility conditioned on a certain neighbor increasing/decreasing its power level. The additional signaling for association changes is conceptually similar for the power control frameworks, but typical embodiments may show some differences since the P2P transmitter/receiver perform slightly different functions depending on the power control framework.

Specifically, in addition to the standard resource partitioning messages, the following signaling exchange may be implemented. It is noted that a specific neighbor may change its resource partitioning state in accordance with the handout operation. The state of the link considered for handout, after the association change has taken place, may depend on the power control framework.

If IoT-projection based power control is used, then after completing the P2P-to-WAN handout, the P2P receiver may not be using any resources, as it is no longer active. Consequently, neighboring nodes of a specific link may send their utility conditioned on the link considered for handout vacating all resources at once. For example, according to FIG. 32A, P2P Links 2 and 3 may send this utility to Link 1 to capture the case of Link 1 being considered for handout to the WAN. In essence, this utility represents the benefit that, after handout, the P2P link's receiver may no longer impose IoT targets on neighboring links.

With continued reference to the embodiment of FIG. 32A, there is shown a system 3200 wherein the eNB sends a utility message 3202 to Rx1 of Link 1. In the utility message 3202, the eNB may convey the utility if Tx1 may need to be served by it, and if P2P Link 1 vacated associated P2P resources. In related aspects, Tx2 of Link 2 may send a utility message 3204 to Rx1 of Link 1. Link 2 may compute its utility conditioned on Link 1 giving up its P2P resources, and may send its computed utility to Rx1 in the utility message 3204. Similarly, Tx3 of Link 3 may send a utility message 3206 to Rx1 of Link 1. Link 3 may compute its utility conditioned on Link 1 giving up its P2P resources, and may send its computed utility to Rx1 in the utility message 3206.

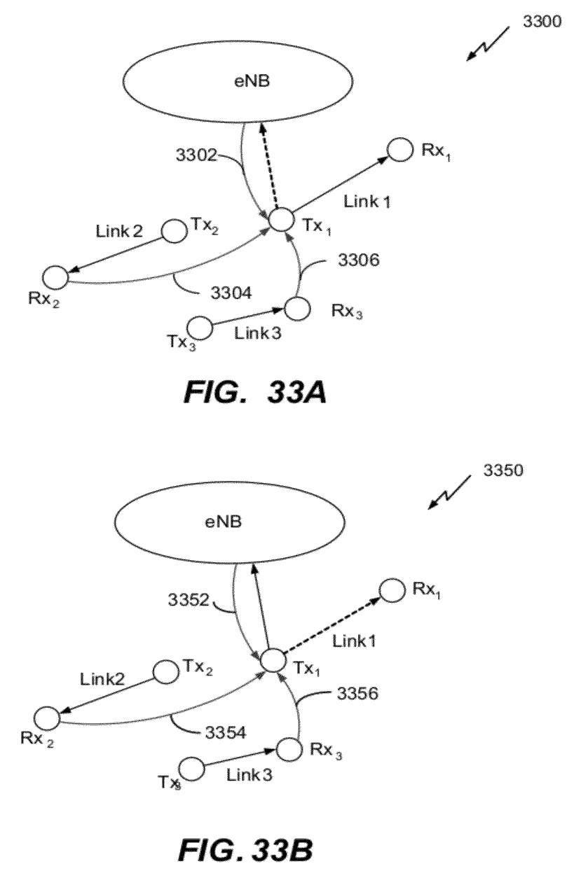

If Tx-PSD based power control is used, then after completing the P2P-to-WAN handout, the P2P transmitter will be using a new set of resources, as controlled by the WAN. Since neighboring links will in general not be able to forecast the specific setting, it is reasonable to assume that the new link first starts off by occupying only a single resource at the first non-zero Tx-PSD setting. This technique may be used to bootstrap further changes in the resource partitioning of the link, performed in negotiation rounds. FIG. 33A illustrates this concept further in the context of Link 1 being considered for handout to the WAN. It should be noted that instead of just one, multiple initial configurations may be considered at the expense of additional signaling overhead.

With continued reference to the embodiment of FIG. 33A, there is shown a system 3300 wherein the eNB sends a utility message 3302 to Tx1 of Link 1. In the utility message 3302, the eNB may convey the utility if Tx1 may need to be served by it, and if P2P Link 1 started to use a specific resource with the first non-zero Tx-PSD. In related aspects, Rx2 of Link 2 may send a utility message 3304 to Tx1 of Link 1. Link 2 may compute its utility conditioned on Link 1 using a specific resource with the first non-zero Tx-PSD setting, and may send its computed utility in the utility message 3304. Similarly, Rx3 of Link 3 may send a utility message 3306 to Tx1 of Link 1. Link 3 may compute its utility conditioned on Link 1 using a specific resource with the first non-zero Tx-PSD setting, and may send its computed utility in the utility message 3306.

The WAN may send a utility message capturing the utility it may achieve if it may have to support the P2P transmitter of Link 1 for uplink transmission, conditioned on P2P Link 1 changing its resource partitioning in accordance with the above discussion.

The P2P link considered for handout aggregates the above two utilities and compares the resulting value with the utility that is currently being achieved. If there is a positive utility change associated with the handout of the P2P link, then the handout may be initiated by the P2P transmitter by sending a trigger to the WAN, for example. To avoid frequent association triggers, it may be beneficial to require that the positive utility changes mentioned above are significant enough to make the association change worthwhile, such as, for example, by requiring that the positive utility change exceed a defined threshold or minimum utility change value.

In the scenarios described above with reference to FIGS. 32A and 33A, the P2P links were viewed as a single entity, although in practice the various functions may be concentrated in either the P2P transmitter or the P2P receiver. The functional split between the P2P transmitter and the P2P receiver may depend on the assumed power control framework. In the above-described scenarios, the utility conditioned on a neighboring P2P link may be computed at the P2P transmitter in case of IoT-projection based power control or at the P2P receiver in case of Tx-PSD based power control. However, in another embodiment, the utility conditioned on a neighboring P2P link may be computed at the P2P receiver in case of IoT-projection based power control or at the P2P transmitter in case of Tx-PSD based power control.

Association change from WAN to P2P association: Changing the association of a P2P device in WAN mode to P2P direct operation may also be carried out at the P2P device, which essentially performs a claim-type operation on a certain resource. For this configuration, the format of the regular utility messages that are being exchanged as part of the resource coordination procedure may be reused, but some additional signaling by the WAN may be needed to capture the utility change associated with no longer having to support the UE.

The exchanged utility metrics depend on the power control framework for this type of association change. The reason for this difference lies in the fact that in the IoT-projection based power control framework, the P2P receivers are typically the entities that broadcast their IoT target. However, this is not performed in this case, since the P2P link is in WAN mode to start with, and therefore the P2P receiver will not be actively using resources. On the other hand, for Tx-PSD based power control frameworks, it is the P2P transmitter that broadcasts its current resource partitioning (as controlled by the WAN).

Several utilities may be considered by the P2P device. In one aspect, the utility associated with a neighboring P2P link may be considered by the P2P device if that link begins to use a single, specific resource while not using any others. In essence this case corresponds to a P2P link changing its association and starting out with the new association and a single resource. More resources may need to be acquired by the link in subsequent negotiation rounds. With reference to FIG. 33B, which illustrates the case of a Tx-PSD-based power control framework, wherein Link 1 is considered for handout to P2P direct, this message may be provided in addition to the standard resource partitioning messages, since the standard resource partitioning messages only consider a single increase/decrease step from the current resource partitioning state. As a consequence, standard utility messages may not provide the requisite information. With reference to FIG. 32B, which illustrates the case of IoT-projection based power control, wherein Link 1 is considered for handout to P2P direct, it may be possible that the requisite information is already conveyed as part of the standard resource partitioning messages. Specifically, in WAN association, a P2P link's receiver may be idle and therefore not broadcasting non-infinity IoT levels. As a result, the standard resource partitioning messaging should already cover the requisite signaling described above. However, if in some embodiments, a given link's P2P receiver does not advertise IoT targets in the manner described above, then additional messaging may be implemented.

With reference once again to the embodiment of FIG. 32B, there is shown a system 3250 wherein the eNB sends a utility message 3252 to Rx1 of Link 1. In the utility message 3252, the eNB may convey its utility conditioned on Tx1 no longer being served by it, and on Link 1 becoming active on a given resource. It is noted that Links 2 and 3 do not need to send additional information since the utility of Link 1 becoming active on the given resource is part of the standard resource partitioning messages.

With reference once again to the embodiment of FIG. 33B, there is shown a system 3350 wherein the eNB sends a utility message 3352 to Tx1 of Link 1. In the utility message 3352, the eNB may convey its utility conditioned on Tx1 no longer being served by it, and on P2P Link 1 using a specific resource with the first non-zero Tx-PSD. In related aspects, Rx2 of Link 2 may send a utility message 3354 to Tx1 of Link 1. Link 2 may determine its utility conditioned on Tx1 being active on only a single resource with the first non-zero Tx-PSD setting, and may convey its utility in the utility message 3354. Similarly, Rx3 of Link 3 may send a utility message 3356 to Tx1 of Link 1. Link 3 may determine its utility conditioned on Tx1 being active on only a single resource with the first non-zero Tx-PSD setting, and may convey its utility in the utility message 3356.

In related aspects, the WAN may convey its utility if the P2P link that is considered to be formed, increases its power level on a specific resource and conditioned on the fact that this UE need no longer be served by the WAN. For example, this metric may be signaled to the UE in a unicast fashion.

Based on the above-described utility metrics, the P2P transmitter considered for an association change may again compute and compare the aggregate utility to the previous one and consider whether an association change may be beneficial.

In some of the scenarios discussed above, it was assumed that after the completion of the handout operation, the P2P link may initially operate with a resource partitioning in which one resource may be used at the smallest non-zero activity level whereas all other resources may be unused. This assumption was made because neighboring P2P links need to assume some starting point when signaling utility messages to their neighbors which are considered for handout. Therefore, the assumption made above, serves as a simple and natural starting point, considering that further refinements to a link's resource partitioning may be performed in subsequent negotiation rounds.

Further optimizations may be included to avoid suboptimal performance due to local optima in the aggregate utility metric. For example, neighboring links may send multiple association-specific utility messages, conditioned on multiple starting points. In this way, the handout-procedure may consider multiple starting points that may be used as initial values after the handout procedure is complete.

It is noted that the WAN may suggest a certain starting point for the resource partitioning after completing the handout procedure and may signal this recommendation to the P2P link, which may relay it to its neighbors. This way, the neighbors may compute the required utility metrics conditioned on the recommended starting point. While overhead may increase as a result of this technique, association changes may be triggered at a slower time scale or on a per-demand basis.

### Methodology & Apparatus Examples Pertaining to Controlling Peer-to-Peer/WAN Association

In view of exemplary systems shown and described in the foregoing section, methodologies that may be implemented in accordance with the disclosed subject matter, will be better appreciated with reference to various flow charts. For purposes of simplicity of explanation, methodologies are shown and described as a series of acts/blocks. It should be apparent that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture such as a non-transitory computer-readable medium to facilitate transporting and transferring such methodologies to various devices, or implementing a methodology using a particular processing device. Those skilled in the art will understand and appreciate that a methodology may alternatively be represented as a series of interrelated states or events, such as in a state diagram.

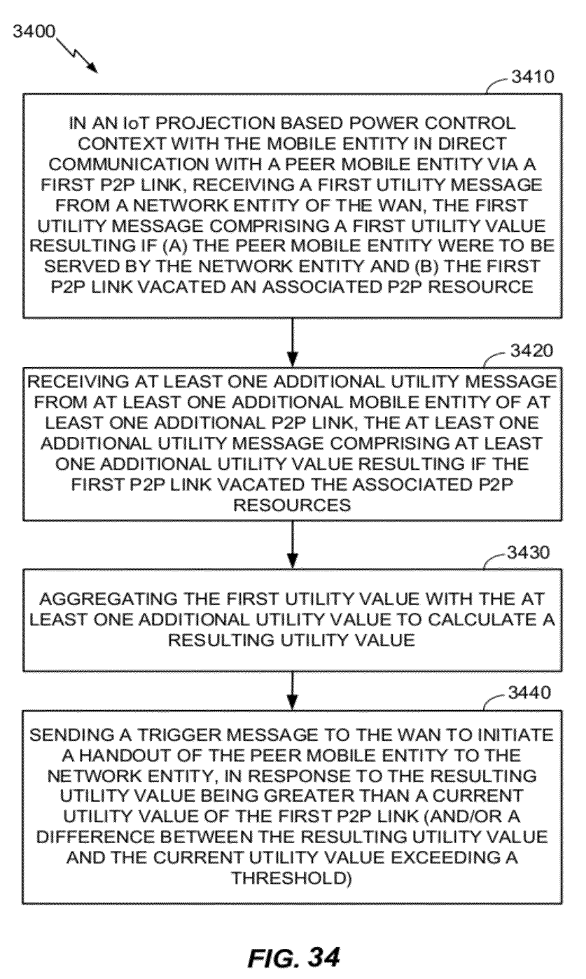

In accordance with one or more aspects of the subject of this disclosure, there are provided methods for making P2P/WAN association decisions based on maximizing aggregate neighborhood utility metrics. With reference to FIG. 34, illustrated is a methodology 3400 that may be performed at a wireless communication apparatus, such as a mobile entity (e.g., a UE), and more specifically by a P2P transmitter/receiver device. In an IoT projection based power control context with the mobile entity in direct communication with a peer mobile entity via a first P2P link, the method 3400 involves a scenario where the first P2P link is considered for handout to the WAN.

With continued reference to FIG. 34, the method 3400 may involve, at 3410, receiving a first utility message from a network entity (e.g., eNB) of the WAN, the first utility message comprising a first utility value resulting if (a) the peer mobile entity were to be served by the network entity and (b) the first P2P link vacated an associated P2P resource. The method 3400 may involve, at 3420, receiving at least one additional utility message from at least one additional mobile entity of at least one additional P2P link, the at least one additional utility message comprising at least one additional utility value resulting if the first P2P link vacated the associated P2P resources. The method 3400 may involve, at 3430, aggregating the first utility value with the at least one additional utility value to calculate a resulting utility value. The method 3400 may involve, at 3440, sending a trigger message to the WAN to initiate a handout of the peer mobile entity to the network entity, in response to the resulting utility value being greater than a current utility value of the first P2P link. In related aspects, block 3440 may comprise sending the trigger message in response to a difference between the resulting utility value and the current utility value exceeding a threshold. In further related aspects, the mobile entity may comprise a first P2P receiver of the first P2P link, and the peer mobile entity may comprise a first P2P transmitter of the first P2P link. The at least one additional mobile entity may comprise a second P2P transmitter of a second P2P link, the second P2P transmitter being in direct communication with a second P2P receiver via the second P2P link.

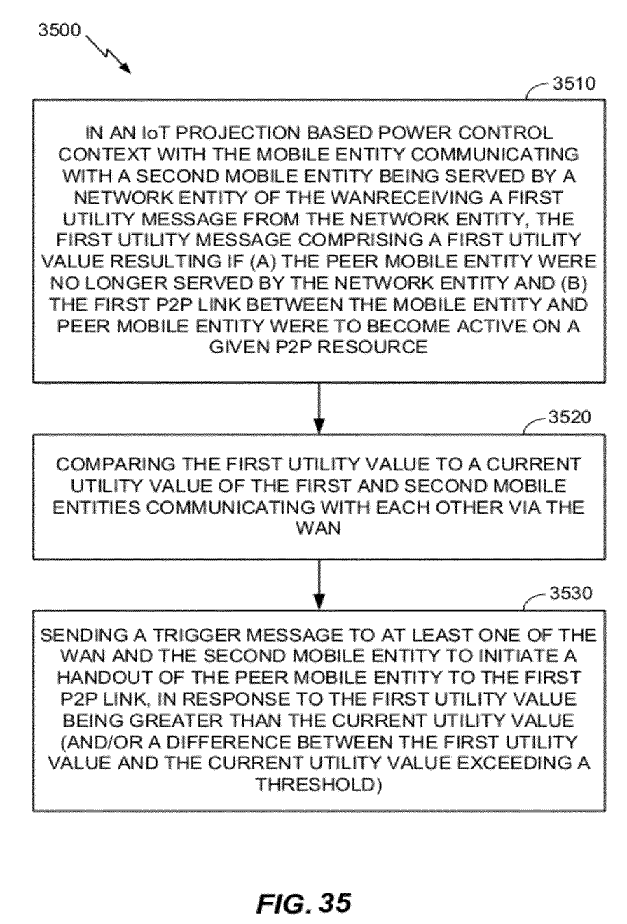

In accordance with one or more aspects of the subject of this disclosure, FIG. 35 illustrates a methodology 3500 for a scenario where a first P2P link is considered for handout to P2P direct. In an IoT projection based power control context with a mobile entity communicating with a second mobile entity being served by a network entity of the WAN, the method 3500 may involve, at 3510, receiving a first utility message from the network entity, the first utility message comprising a first utility value resulting if (a) the peer mobile entity were no longer served by the network entity and (b) the first P2P link between the mobile entity and peer mobile entity were to become active on a given P2P resource. The method 3500 may involve, at 3520, comparing the first utility value to a current utility value of the first and second mobile entities communicating with each other via the WAN. The method 3500 may involve, at 3530, sending a trigger message to at least one of the WAN and the second mobile entity to initiate a handout of the peer mobile entity to the first P2P link, in response to the first utility value being greater than the current utility value. In related aspects, block 3530 may comprise sending the trigger message in response to a difference between the first utility value and the current utility value exceeding a threshold. In further related aspects, the mobile entity may comprise a first P2P receiver of the first P2P link, whereas the second mobile entity may comprise a first P2P transmitter of the first P2P link.

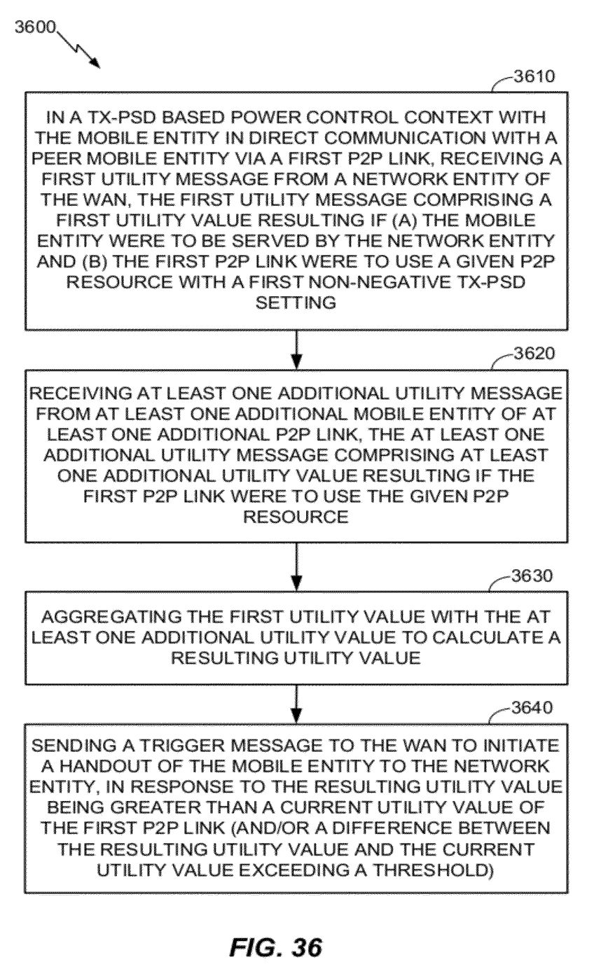

In accordance with one or more aspects of the subject of this disclosure, FIG. 36 illustrates a methodology 3600 for a scenario where a first P2P link is considered for handout to the WAN. In a Tx-PSD based power control context with a mobile entity in direct communication with a peer mobile entity via a first P2P link, the method 3600 may involve, at 3610, receiving a first utility message from a network entity of the WAN, the first utility message comprising a first utility value resulting if (a) the mobile entity were to be served by the network entity and (b) the first P2P link were to use a given P2P resource with a first non-zero Tx-PSD setting. The method 3600 may involve, at 3620, receiving at least one additional utility message from at least one additional mobile entity of at least one additional P2P link, the at least one additional utility message comprising at least one additional utility value resulting if the first P2P link were to use the given P2P resource. The method 3600 may involve, at 3630, aggregating the first utility value with the at least one additional utility value to calculate a resulting utility value. The method 3600 may involve, at 3640, sending a trigger message to the WAN to initiate a handout of the mobile entity to the network entity, in response to the resulting utility value being greater than a current utility value of the first P2P link. In related aspects, block 3640 may comprise sending the trigger message in response to a difference between the resulting utility value and the current utility value exceeding a threshold. In further related aspects, the mobile entity may comprise a first P2P transmitter of the first P2P link, whereas the peer mobile entity may comprise a first P2P receiver of the first P2P link. The at least one additional mobile entity may comprise a second P2P receiver of a second P2P link, the second P2P receiver being in direct communication with a second P2P transmitter via the second P2P link.

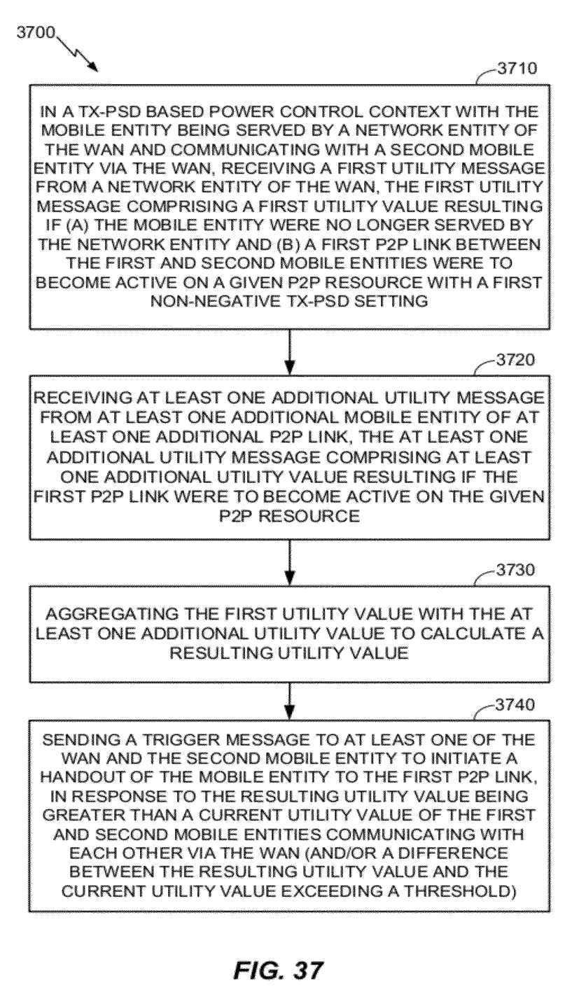

In accordance with one or more aspects of the subject of this disclosure, FIG. 37 illustrates a methodology 3700 for a scenario where a first P2P link is considered for handout to P2P direct. In a Tx-PSD based power control context with the mobile entity being served by a network entity of the WAN and communicating with a second mobile entity via the WAN, the method 3700 may involve, at 3710, receiving a first utility message from a network entity of the WAN, the first utility message comprising a first utility value resulting if (a) the mobile entity were no longer served by the network entity and (b) a first P2P link between the first and second mobile entities were to become active on a given P2P resource with a first non-zero Tx-PSD setting. The method 3700 may involve, at 3720, receiving at least one additional utility message from at least one additional mobile entity of at least one additional P2P link, the at least one additional utility message comprising at least one additional utility value resulting if the first P2P link were to become active on the given P2P resource. The method 3700 may involve, at 3730, aggregating the first utility value with the at least one additional utility value to calculate a resulting utility value. The method 3700 may involve, at 3740, sending a trigger message to at least one of the WAN and the second mobile entity to initiate a handout of the mobile entity to the first P2P link, in response to the resulting utility value being greater than a current utility value of the first and second mobile entities communicating with each other via the WAN. In related aspects, block 3740 may comprise sending the trigger message in response to a difference between the resulting utility value and the current utility value exceeding a threshold. In further related aspects, the mobile entity may comprise a first P2P transmitter of the first P2P link, and the second mobile entity may comprise a first P2P receiver of the first P2P link. The at least one additional mobile entity may comprise a second P2P receiver of a second P2P link, the second P2P receiver being in direct communication with a second P2P transmitter via the second P2P link.

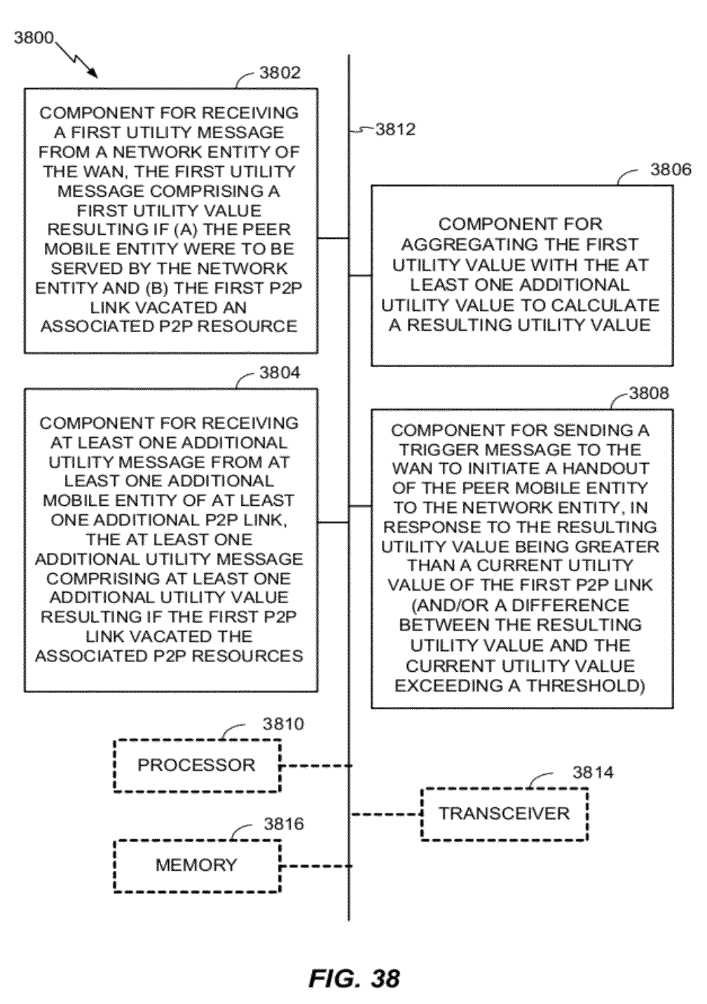

In accordance with one or more aspects of the embodiments described herein, there are provided devices and apparatuses for deciding P2P/WAN associations, as described above with reference to FIG. 34. With reference to FIG. 38, there is provided an exemplary mobile apparatus 3800 that may be configured as a mobile entity in a wireless network, or as a processor or similar device for use within the mobile entity. The apparatus 3800 may include functional blocks that may represent functions implemented by a processor, software, or combination thereof (e.g., firmware).

In an IoT projection based power control context with the mobile entity in direct communication with a peer mobile entity via a first P2P link, the apparatus 3800 of FIG. 38 may comprise an electrical component or module 3802 for receiving a first utility message from a network entity of the WAN, the first utility message comprising a first utility value resulting if (a) the peer mobile entity were to be served by the network entity and (b) the first P2P link vacated an associated P2P resource. The component 3802 may be, or may include, a means for receiving a first utility message from a network entity of the WAN, the first utility message comprising a first utility value resulting if (a) the peer mobile entity were to be served by the network entity and (b) the first P2P link vacated an associated P2P resource. Said means may include the at least one control processor 3810 operating an algorithm. The algorithm may include, for example, receiving the message from the network entity, and identifying the first utility value in the message.

The apparatus 3800 may comprise an electrical component 3804 for receiving at least one additional utility message from at least one additional mobile entity of at least one additional P2P link, the at least one additional utility message comprising at least one additional utility value resulting if the first P2P link vacated the associated P2P resources. The component 3804 may be, or may include, a means for receiving at least one additional utility message from at least one additional mobile entity of at least one additional P2P link, the at least one additional utility message comprising at least one additional utility value resulting if the first P2P link vacated the associated P2P resources. Said means may include the at least one control processor 3810 operating an algorithm. The algorithm may include, for example, receiving additional messages from one or more mobile entities, and processing the messages to identify the at least one additional utility value.

The apparatus 3800 may comprise an electrical component 3806 for aggregating the first utility value with the at least one additional utility value to calculate a resulting utility value. The component 3806 may be, or may include, a means for aggregating the first utility value with the at least one additional utility value to calculate a resulting utility value. Said means may include the at least one control processor 3810 operating an algorithm. The algorithm may include, for example, any of the more detailed aggregation algorithms described elsewhere herein.

The apparatus 3800 may comprise an electrical component 3808 for sending a trigger message to the WAN to initiate a handout of the peer mobile entity to the network entity, in response to the resulting utility value being greater than a current utility value of the first P2P link and/or a difference between the resulting utility value and the current utility value exceeding a threshold. The component 3808 may be, or may include, a means for sending a trigger message to the WAN to initiate a handout of the peer mobile entity to the network entity, in response to the resulting utility value being greater than a current utility value of the first P2P link and/or a difference between the resulting utility value and the current utility value exceeding a threshold. Said means may include the at least one control processor 3810 operating an algorithm. The algorithm may include, for example, determining a different between the resulting utility value and the current utility value, and triggering a handout message to the WAN based on a value of the difference.

In related aspects, the apparatus 3800 may optionally include a processor component 3810 having at least one processor, in the case of the apparatus 3800 configured as a network entity, rather than as a processor. The processor 3810, in such case, may be in operative communication with the components 3802-3808 via a bus 3812 or similar communication coupling. The processor 3810 may effect initiation and scheduling of the processes or functions performed by electrical components 3802-3808.

In further related aspects, the apparatus 3800 may include a radio transceiver component 3814. A stand alone receiver and/or stand alone transmitter may be used in lieu of or in conjunction with the transceiver 3814. The apparatus 3800 may optionally include a component for storing information, such as, for example, a memory device/component 3816. The computer readable medium or the memory component 3816 may be operatively coupled to the other components of the apparatus 3800 via the bus 3812 or the like. The memory component 3816 may be adapted to store computer readable instructions and data for putting the processes and behavior of the components 3802-3808, and subcomponents thereof, or the processor 3810, or the methods disclosed herein into effect. The memory component 3816 may retain instructions for executing functions associated with the components 3802-3808. While shown as being external to the memory 3816, it is to be understood that the components 3802-3808 may exist within the memory 3816.

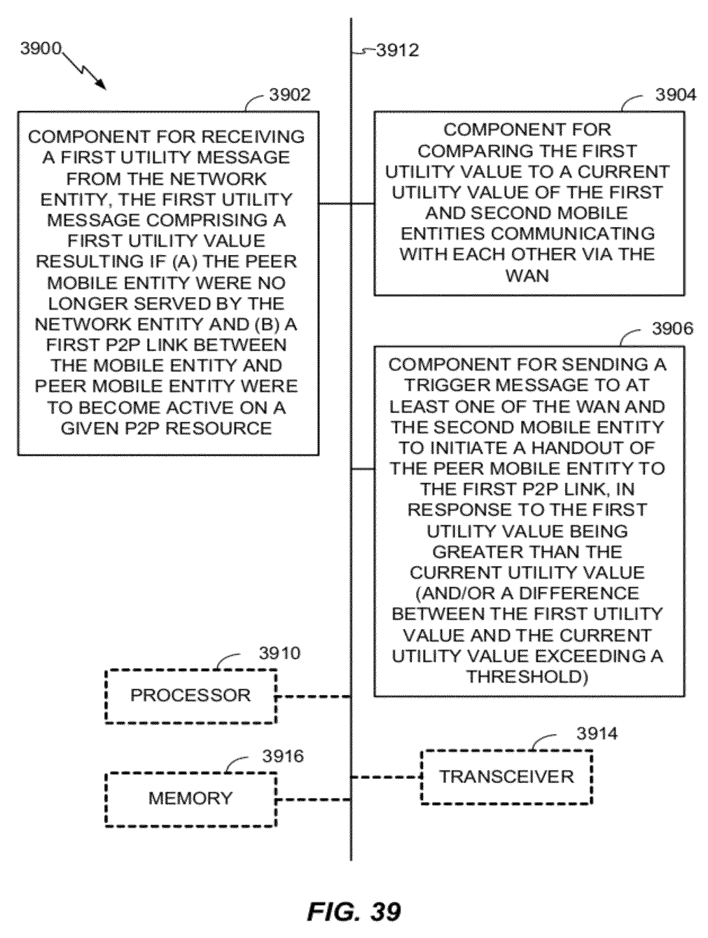

In accordance with one or more aspects of the embodiments described herein, there are provided devices and apparatuses (e.g., mobile entities) for deciding P2P/WAN associations, as described above with reference to FIG. 35. With reference to FIG. 39, in an IoT projection based power control context with the mobile entity communicating with a second mobile entity being served by a network entity of the WAN, the apparatus 3900 may comprise an electrical component or module 3902 for receiving a first utility message from the network entity, the first utility message comprising a first utility value resulting if (a) the peer mobile entity were no longer served by the network entity and (b) a first P2P link between the mobile entity and peer mobile entity were to become active on a given P2P resource. The component 3902 may be, or may include, a means for receiving a first utility message from the network entity, the first utility message comprising a first utility value resulting if (a) the peer mobile entity were no longer served by the network entity and (b) a first P2P link between the mobile entity and peer mobile entity were to become active on a given P2P resource. Said means may include the at least one control processor 3910 operating an algorithm. The algorithm may include, for example, receiving a message from the network entity, and processing the message to identify a first utility value resulting if (a) the peer mobile entity were no longer served by the network entity and (b) a first P2P link between the mobile entity and peer mobile entity were to become active on a given P2P resource.

The apparatus 3900 may comprise an electrical component 3904 for comparing the first utility value to a current utility value of the first and second mobile entities communicating with each other via the WAN. The component 3904 may be, or may include, a means for comparing the first utility value to a current utility value of the first and second mobile entities communicating with each other via the WAN. Said means may include the at least one control processor 3910 operating an algorithm. The algorithm may include, for example, determining the current utility value using any of the more detailed measures as described elsewhere herein, and determining a different between the current utility value and the first utility value.

The apparatus 3900 may comprise an electrical component 3906 for sending a trigger message to at least one of the WAN and the second mobile entity to initiate a handout of the peer mobile entity to the first P2P link, in response to the first utility value being greater than the current utility value and/or a difference between the first utility value and the current utility value exceeding a threshold. The component 3906 may be, or may include, a means for sending a trigger message to at least one of the WAN and the second mobile entity to initiate a handout of the peer mobile entity to the first P2P link, in response to the first utility value being greater than the current utility value and/or a difference between the first utility value and the current utility value exceeding a threshold. Said means may include the at least one control processor 3910 operating an algorithm. The algorithm may include, for example, evaluating the difference to ascertain the first utility value is greater than the current utility value, optionally by more than a threshold amount, using any suitable arithmetic operation, and triggering transmission of the message to initiate handout of the peer mobile entity to the first P2P link, based on the evaluating.

For the sake of conciseness, the rest of the details regarding apparatus 3900 are not further elaborated on; however, it is to be understood that the remaining features and aspects of the apparatus 3900, for example the processor 3910, the memory 3916, the transceiver 3914 or the bus 3912, may be the same as or substantially similar to those described above with respect to apparatus 3800 of FIG. 38.

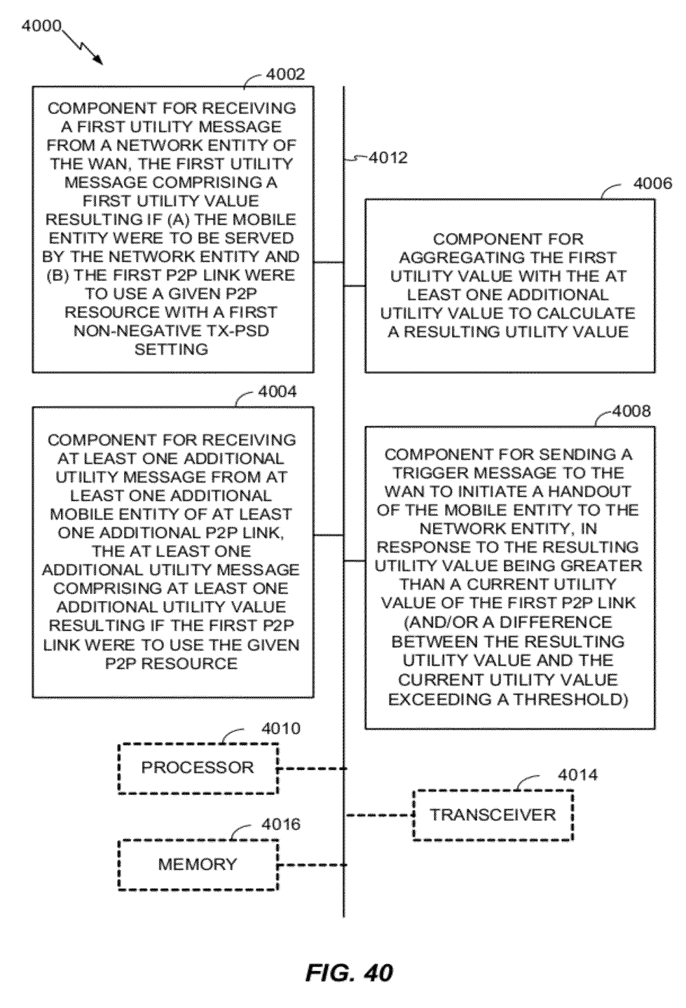

In accordance with one or more aspects of the embodiments described herein, there are provided devices and apparatuses for deciding P2P/WAN associations, as described above with reference to FIG. 36. With reference to FIG. 40, in a Tx-PSD based power control context with the mobile entity in direct communication with a peer mobile entity via a first P2P link, the apparatus 4000 may comprise an electrical component or module 4002 for receiving a first utility message from a network entity of the WAN, the first utility message comprising a first utility value resulting if (a) the mobile entity were to be served by the network entity and (b) the first P2P link were to use a given P2P resource with a first non-zero Tx-PSD setting. The component 4002 may be, or may include, a means for receiving a first utility message from a network entity of the WAN, the first utility message comprising a first utility value resulting if (a) the mobile entity were to be served by the network entity and (b) the first P2P link were to use a given P2P resource with a first non-zero Tx-PSD setting. Said means may include the at least one control processor 4010 operating an algorithm. The algorithm may include, for example, receiving a message from a network entity, and processing the message to identify the prospective utility values resulting if (a) the mobile entity were to be served by the network entity and (b) the first P2P link were to use a given P2P resource with a first non-zero Tx-PSD setting.

The apparatus 4000 may comprise an electrical component 4004 for receiving at least one additional utility message from at least one additional mobile entity of at least one additional P2P link, the at least one additional utility message comprising at least one additional utility value resulting if the first P2P link were to use the given P2P resource. The component 4004 may be, or may include, a means for receiving at least one additional utility message from at least one additional mobile entity of at least one additional P2P link, the at least one additional utility message comprising at least one additional utility value resulting if the first P2P link were to use the given P2P resource. Said means may include the at least one control processor 4010 operating an algorithm. The algorithm may include, for example, receiving a message from a mobile entity, and processing the message to identify at least one additional utility value resulting if the first P2P link were to use the given P2P resource.

The apparatus 4000 may comprise an electrical component 4006 for aggregating the first utility value with the at least one additional utility value to calculate a resulting utility value. The component 4006 may be, or may include, a means for aggregating the first utility value with the at least one additional utility value to calculate a resulting utility value. Said means may include the at least one control processor 4010 operating an algorithm. The algorithm may include, for example, a summation, a weighted average, an average, or other arithmetic operation for aggregating two or more values in a consistent fashion, for which certain more detailed examples have been provided herein above.

The apparatus 4000 may comprise an electrical component 4008 for sending a trigger message to the WAN to initiate a handout of the mobile entity to the network entity, in response to the resulting utility value being greater than a current utility value of the first P2P link and/or a difference between the resulting utility value and the current utility value exceeding a threshold. The component 4008 may be, or may include, a means for sending a trigger message to the WAN to initiate a handout of the mobile entity to the network entity, in response to the resulting utility value being greater than a current utility value of the first P2P link and/or a difference between the resulting utility value and the current utility value exceeding a threshold. Said means may include the at least one control processor 4010 operating an algorithm. The algorithm may include, for example, evaluating the difference to ascertain the resulting utility value is greater than the current utility value, optionally by more than a threshold amount, using any suitable arithmetic operation, and triggering transmission of the message to initiate handout of the mobile entity to the network entity, based on the evaluating.

For the sake of conciseness, the rest of the details regarding apparatus 4000 are not further elaborated on; however, it is to be understood that the remaining features and aspects of the apparatus 4000, for example the processor 4010, the memory 4016, the transceiver 4014 or the bus 4012, may be the same as or substantially similar to those described above with respect to apparatus 3800 of FIG. 38.

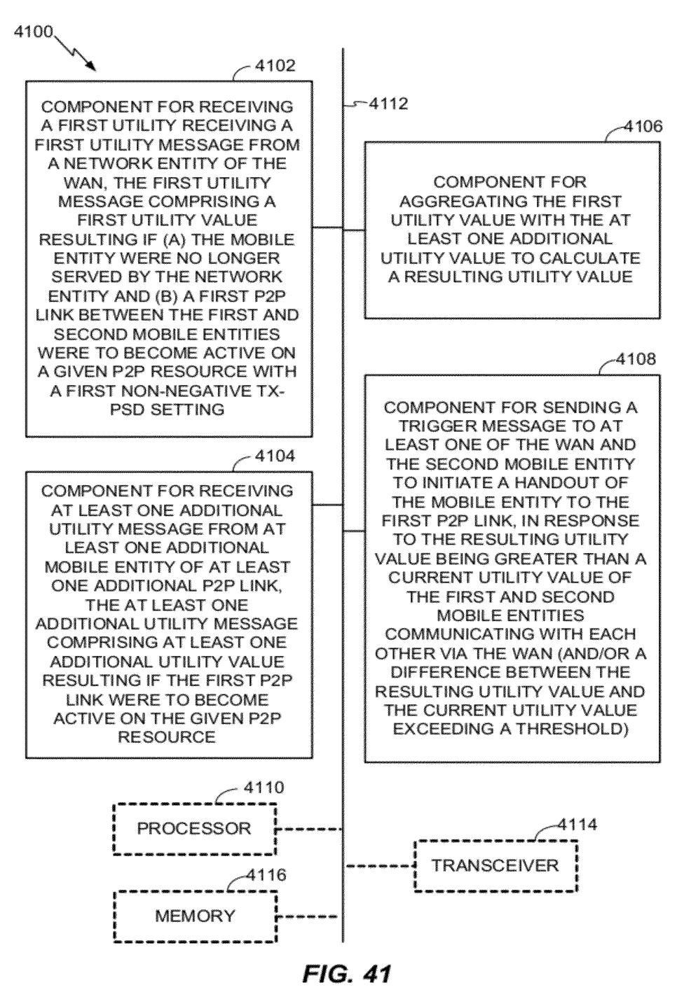

In accordance with one or more aspects of the embodiments described herein, there are provided devices and apparatuses for deciding P2P/WAN associations, as described above with reference to FIG. 37. With reference to FIG. 41, in a Tx-PSD based power control context with the mobile entity being served by a network entity of the WAN and communicating with a second mobile entity via the WAN, the apparatus 4100 may comprise an electrical component or module 4102 for receiving a first utility message from a network entity of the WAN, the first utility message comprising a first utility value resulting if (a) the mobile entity were no longer served by the network entity and (b) a first P2P link between the first and second mobile entities were to become active on a given P2P resource with a first non-zero Tx-PSD setting. The component 4002 may be, or may include, a means for receiving a first utility message from a network entity of the WAN, the first utility message comprising a first utility value resulting if (a) the mobile entity were no longer served by the network entity and (b) a first P2P link between the first and second mobile entities were to become active on a given P2P resource with a first non-zero Tx-PSD setting. Said means may include the at least one control processor 4110 operating an algorithm. The algorithm may include, for example, receiving a message from a network entity, and processing the message to identify the prospective utility values resulting if (a) the mobile entity were no longer served by the network entity and (b) the first P2P link were to become active on a given P2P resource with a first non-zero Tx-PSD setting.

The apparatus 4100 may comprise an electrical component 4104 for receiving at least one additional utility message from at least one additional mobile entity of at least one additional P2P link, the at least one additional utility message comprising at least one additional utility value resulting if the first P2P link were to become active on the given P2P resource. The component 4104 may be, or may include, a means for receiving at least one additional utility message from at least one additional mobile entity of at least one additional P2P link, the at least one additional utility message comprising at least one additional utility value resulting if the first P2P link were to become active on the given P2P resource. Said means may include the at least one control processor 4110 operating an algorithm. The algorithm may include, for example, receiving a message from a mobile entity, and processing the message to identify at least one additional utility value resulting if the first P2P link were to become active on the given P2P resource.

The apparatus 4100 may comprise an electrical component 4106 for aggregating the first utility value with the at least one additional utility value to calculate a resulting utility value. The component 4106 may be, or may include, a means for aggregating the first utility value with the at least one additional utility value to calculate a resulting utility value. Said means may include the at least one control processor 4110 operating an algorithm. The algorithm may include, for example, a summation, a weighted average, an average, or other arithmetic operation for aggregating two or more values in a consistent fashion, for which certain more detailed examples have been provided herein above.

The apparatus 4100 may comprise an electrical component 4108 for sending a trigger message to at least one of the WAN and the second mobile entity to initiate a handout of the mobile entity to the first P2P link, in response to the resulting utility value being greater than a current utility value of the first and second mobile entities communicating with each other via the WAN and/or a difference between the resulting utility value and the current utility value exceeding a threshold. As noted above, to avoid frequent association triggers, it may be beneficial to require that such positive utility changes are significant enough to make the association change worthwhile, such as, for example, by requiring that the positive utility change exceed a given or user-defined minimum threshold. The component 4108 may be, or may include, a means for sending a trigger message to at least one of the WAN and the second mobile entity to initiate a handout of the mobile entity to the first P2P link, in response to the resulting utility value being greater than a current utility value of the first and second mobile entities communicating with each other via the WAN and/or a difference between the resulting utility value and the current utility value exceeding a threshold. Said means may include the at least one control processor 4110 operating an algorithm. The algorithm may include, for example, evaluating the difference to ascertain the resulting utility value is greater than the current utility value, optionally by more than a threshold amount, using any suitable arithmetic operation, and triggering transmission of the message to initiate handout of the mobile entity handout of the mobile entity to the first P2P link, based on the evaluating.

For the sake of conciseness, the rest of the details regarding apparatus 4100 are not further elaborated on; however, it is to be understood that the remaining features and aspects of the apparatus 4100, for example the processor 4110, the memory 4116, the transceiver 4114 or the bus 4112, may be the same as or substantially similar to those described above with respect to apparatus 3800 of FIG. 38.

### General Remarks

In the forgoing disclosure, headings and sub-heading are used to identify corresponding sections and sub-sections of the disclosure solely for the convenience of the reader, and should not be construed for any other purpose. Such headings and sub-headings should not be used to limit application of the innovative subject matter disclosed herein, or to alter the meaning thereof. It should be understood that the specific order or hierarchy of steps in the methods disclosed herein comprise examples of possible approaches. Based upon design preferences, it is understood that the specific order or hierarchy of steps in the methods may be rearranged while remaining within the scope of the present disclosure. The accompanying method claims present elements of the various steps in a sample order, and are not meant to be limited to the specific order or hierarchy presented.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Non-transitory computer-readable media includes both computer storage media and temporary memory media, whether or not used for transfer of a computer program from one place to another. A storage media may include any available medium that can be accessed by a processor and used to hold data for retrieval by the processor at some future time. By way of example, and not limitation, such non-transitory computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes Compact Disc (CD), laser disc, optical disc, Digital Versatile Disc (DVD), floppy disk and Blu-ray disc, where “disks” usually refers to media that holds magnetically encoded data, and “discs” usually refers to media that holds optically encoded data. Combinations of the above should also be included within the scope of non-transitory computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for controlling activity of direct peer-to-peer links between mobile entities of a wireless communication system, the method comprising:
periodically broadcasting an activity level indicator from one of a pair of mobile entities participating in a peer-to-peer link, wherein the activity level indicator indicates a resource-dependent activity level of the link determined by the one of the pair of mobile entities; and
controlling the activity level in response to utility metrics received from members of neighboring peer-to-peer links to maximize an aggregate utility of the link and the neighboring peer-to-peer links sharing at least a subset of resources of a common frequency spectrum.

2. The method of claim 1, further comprising determining the activity level indicator comprising a targeted interference-over-thermal (IoT) value provided by a receiving node of the peer-to-peer link to neighboring transmitting nodes.

3. The method of claim 1, further comprising determining the activity level indicator comprising a transmission power spectral density (PSD) value provided by a transmitting node of the peer-to-peer link to neighboring receiving nodes.

4. The method of claim 1, further comprising determining the activity level indicator comprising a set of path loss compensation factors provided by a transmitting node of the peer-to-peer link to neighboring receiving nodes.

5. The method of claim 1, further comprising controlling the activity level in response to additional utility metrics received from one or more non-paired mobile entities that are not participating in a peer-to-peer link and are being served by an eNB of the wireless communication system, to maximize an aggregate utility of the link, the neighboring peer-to-peer links, and links between the non-paired mobile entities and the eNB, all sharing at least a subset of a common frequency spectrum, wherein the additional utility metrics indicate an estimated amount by which a change in activity level of the link will affect utility of the links to the non-paired mobile entities served by the eNB.

6. An apparatus, comprising:
at least one processor configured to: periodically broadcast an activity level indicator from one of a pair of mobile entities participating in a peer-to-peer link, wherein the activity level indicator indicates a resource-dependent activity level of the link determined by the one of the pair of mobile entities, and control the activity level in response to utility metrics received from members of neighboring peer-to-peer links to maximize an aggregate utility of the link and the neighboring peer-to-peer links sharing at least a subset of resources of a common frequency spectrum; and
a memory coupled to the at least one processor for storing data.

7. The apparatus of claim 6, wherein the processor is further configured for determining the activity level indicator comprising a targeted interference-over-thermal (IoT) value provided by a receiving node of the peer-to-peer link to neighboring transmitting nodes.

8. The apparatus of claim 6, wherein the processor is further configured for determining the activity level indicator comprising a transmission power spectral density (PSD) value provided by a transmitting node of the peer-to-peer link to neighboring receiving nodes.

9. The apparatus of claim 6, wherein the processor is further configured for determining the activity level indicator comprising a set of path loss compensation factors provided by a transmitting node of the peer-to-peer link to neighboring receiving nodes.

10. The apparatus of claim 6, wherein the processor is further configured for controlling the activity level in response to additional utility metrics received from one or more non-paired mobile entities that are not participating in a peer-to-peer link and are being served by an eNB of the wireless communication system, to maximize an aggregate utility of the link, the neighboring peer-to-peer links, and links between the non-paired mobile entities and the eNB, all sharing a at least a subset of a common frequency spectrum, wherein the additional utility metrics indicate an estimated amount by which a change in activity level of the link will affect utility of the links to the non-paired mobile entities served by the eNB.

11. An apparatus, comprising:
means for periodically broadcasting an activity level indicator from one of a pair of mobile entities participating in a peer-to-peer link, wherein the activity level indicator indicates a resource-dependent activity level of the link determined by the one of the pair of mobile entities; and
means for controlling the activity level in response to utility metrics received from members of neighboring peer-to-peer links to maximize an aggregate utility of the link and the neighboring peer-to-peer links sharing at least a subset of resources of a common frequency spectrum.

12. A computer program product, comprising:
a non-transitory computer-readable medium comprising code for causing a mobile entity to: periodically broadcast an activity level indicator from one of a pair of mobile entities participating in a peer-to-peer link, wherein the activity level indicator indicating a resource-dependent activity level of the peer-to-peer link determined by the one of the pair of mobile entities, and control the activity level in response to utility metrics received from members of neighboring peer-to-peer links to maximize an aggregate utility of the link and the neighboring peer-to-peer links sharing at least a subset of resources of a common frequency spectrum.

13. A method for controlling activity of direct peer-to-peer links between mobile entities of a wireless communication system sharing at least a subset of a common frequency spectrum, the method comprising:
periodically receiving, at a first mobile entity, an activity level indicator broadcast from a first peer-to-peer link in which the first mobile entity is not participating, wherein the activity level indicator indicates a resource-dependent activity level of the first link determined by a second mobile entity participating in the first link;
computing a utility metric comprising at least one of a relative utility metric or an absolute utility metric for a second link in which the first mobile entity is participating, in response to receiving the activity level indicator; and
providing the utility metric to the second mobile entity.

14. The method of claim 13, further comprising receiving the activity level indicator comprising a targeted interference-over-thermal (IoT) value provided by a receiving node of the first link to neighboring transmitting nodes, wherein the second link is a peer-to-peer link.

15. The method of claim 13, further comprising receiving the activity level indicator comprising a transmission power spectral density (PSD) value provided by a transmitting node of the first link to neighboring receiving nodes, wherein the second link is a peer-to-peer link.

16. The method of claim 13, further comprising receiving the activity level indicator comprising a resource-dependent set of path loss compensation factors provided by a transmitting node of the first link to neighboring receiving nodes, wherein the second link is a peer-to-peer link.

17. The method of claim 13, further comprising receiving a second activity indicator from an eNB of the wireless communication system, indicating its activity level for links to non-paired mobile entities that are not participating in peer-to-peer communication.

18. The method of claim 17, further comprising computing a second utility metric indicating an estimated amount by which a change in activity level of the eNB will affect a utility for the second link, wherein the second link is a peer-to-peer link.

19. The method of claim 18, further comprising transmitting the second utility metric to the eNB of the wireless communication system.

20. A method for controlling activity of direct peer-to-peer links between mobile entities of a wireless communication system, the method comprising:
periodically broadcasting an activity level indicator from an eNB of the wireless communication system, wherein the activity level indicator indicates a resource-dependent activity level of links to non-paired mobile entities that are not participating in a peer-to-peer communication; and
controlling the activity level of the eNB in response to utility metrics received from members of neighboring peer-to-peer links to maximize an aggregate utility of the link and the neighboring peer-to-peer links sharing at least a subset of a common frequency spectrum, wherein each of the utility metrics comprises at least one of a relative utility metric or an absolute utility metric.

21. The method of claim 20, further comprising determining the activity level indicator comprising a targeted interference-over-thermal (IoT) value for the eNB.

22. The method of claim 20, further comprising determining the activity level indicator comprising a transmission power spectral density (PSD) value for the non-paired mobile entities communicating with the eNB.

23. The method of claim 20, further comprising determining the activity level indicator comprising a set of path loss compensation factors for the non-paired mobile entities communicating with the eNB.

24. The method of claim 20, further comprising periodically receiving an incoming activity level indicator broadcast from a node of a peer-to-peer link in which the eNB is not participating, wherein the activity level indicator indicates an activity level of the peer-to-peer link.

25. The method of claim 24, further comprising computing an eNB utility metric indicating an estimated amount by which a change in activity level of the peer-to-peer link will affect a utility for the links to the non-paired mobile entities, in response to receiving the incoming activity level indicator.

26. A method, comprising:
receiving, at a first mobile entity, a utility metric from a second mobile entity pertaining to a peer-to-peer link that does not include the first mobile entity, wherein the peer-to-peer link shares at least a portion of a common frequency spectrum with a link between the first mobile entity and an eNB of a wireless communication system;
transmitting the utility metric from the first mobile entity to the eNB to provoke an adjustment in a resource-dependent activity level for the link between the first mobile entity and the eNB; and
controlling, at the first mobile entity, an activity level for the link to the eNB as specified by an activity level indicator determined by the eNB in response to the utility metric for the peer-to-peer link.

27. The method of claim 26, further comprising controlling the activity level as specified by the activity level indicator comprising a transmission power spectral density (PSD) value.

28. The method of claim 26, further comprising controlling the activity level as specified by the activity level indicator comprising a set of path loss compensation factors.

29. A method, comprising:
receiving, at a first mobile entity, an activity level indicator from a second mobile entity indicating a resource-dependent activity level for a peer-to-peer link that does not include the first mobile entity, wherein the peer-to-peer link shares at least a portion of a common frequency spectrum with a link between the first mobile entity and an eNB of a wireless communication system;
transmitting the activity level indicator from the first mobile entity to the eNB to provoke determination of an adjusted activity level indicator and a utility metric for the links between non-paired mobile entities served by the eNB and the eNB; and
controlling, at the first mobile entity, an activity level for the link to the eNB as specified by the adjusted activity level indicator determined by the eNB in response to the activity level indicator for the peer-to-peer link.

30. The method of claim 29, further comprising controlling the activity level as specified by the activity level indicator comprising a targeted interference-over-thermal (IoT) value.

31. A method for controlling association changes between peer-to-peer (P2P) and wide area network (WAN) links by a mobile entity, comprising:
in an Interference-over-Thermal (IoT) projection based power control context with the mobile entity in direct communication with a peer mobile entity via a first P2P link, receiving a first utility message from a network entity of the WAN, the first utility message comprising a first utility value resulting if (a) the peer mobile entity were to be served by the network entity and (b) the first P2P link vacated an associated P2P resource;
receiving at least one additional utility message from at least one additional mobile entity of at least one additional P2P link, the at least one additional utility message comprising at least one additional utility value resulting if the first P2P link vacated the associated P2P resources;
aggregating the first utility value with the at least one additional utility value to calculate a resulting utility value; and
sending a trigger message to the WAN to initiate a handout of the peer mobile entity to the network entity, in response to the resulting utility value being greater than a current utility value of the first P2P link.

32. The method of claim 31, wherein sending comprises sending the trigger message in response to a difference between the resulting utility value and the current utility value exceeding a threshold.

33. The method of claim 31, wherein:
the mobile entity comprises a first P2P receiver of the first P2P link;
the peer mobile entity comprises a first P2P transmitter of the first P2P link; and
the at least one additional mobile entity comprises a second P2P transmitter of a second P2P link, the second P2P transmitter being in direct communication with a second P2P receiver via the second P2P link.

34. An apparatus for controlling association changes between peer-to-peer (P2P) and wide area network (WAN) links by a mobile entity, comprising:
at least one processor configured to: in an Interference-over-Thermal (IoT) projection based power control context with the mobile entity in direct communication with a peer mobile entity via a first P2P link, receive a first utility message from a network entity of the WAN, the first utility message comprising a first utility value resulting if (a) the peer mobile entity were to be served by the network entity and (b) the first P2P link vacated an associated P2P resource; receive at least one additional utility message from at least one additional mobile entity of at least one additional P2P link, the at least one additional utility message comprising at least one additional utility value resulting if the first P2P link vacated the associated P2P resources; aggregate the first utility value with the at least one additional utility value to calculate a resulting utility value; and send a trigger message to the WAN to initiate a handout of the peer mobile entity to the network entity, in response to the resulting utility value being greater than a current utility value of the first P2P link; and
a memory coupled to the at least one processor for storing data.

35. The apparatus of claim 34, wherein the at least one processor sends the trigger message in response to a difference between the resulting utility value and the current utility value exceeding a threshold.

36. The apparatus of claim 34, wherein:
the mobile entity comprises a first P2P receiver of the first P2P link;
the peer mobile entity comprises a first P2P transmitter of the first P2P link; and
the at least one additional mobile entity comprises a second P2P transmitter of a second P2P link, the second P2P transmitter being in direct communication with a second P2P receiver via the second P2P link.

37. An apparatus for controlling association changes between peer-to-peer (P2P) and wide area network (WAN) links by a mobile entity, comprising:
in an Interference-over-Thermal (IoT) projection based power control context with the mobile entity in direct communication with a peer mobile entity via a first P2P link, means for receiving a first utility message from a network entity of the WAN, the first utility message comprising a first utility value resulting if (a) the peer mobile entity were to be served by the network entity and (b) the first P2P link vacated an associated P2P resource;
means for receiving at least one additional utility message from at least one additional mobile entity of at least one additional P2P link, the at least one additional utility message comprising at least one additional utility value resulting if the first P2P link vacated the associated P2P resources;
means for aggregating the first utility value with the at least one additional utility value to calculate a resulting utility value; and
means for sending a trigger message to the WAN to initiate a handout of the peer mobile entity to the network entity, in response to the resulting utility value being greater than a current utility value of the first P2P link.

38. A computer program product, comprising:
a non-transitory computer-readable medium comprising code for causing a computer to:
in an Interference-over-Thermal (IoT) projection based power control context with the mobile entity in direct communication with a peer mobile entity via a first P2P link, receive a first utility message from a network entity of the WAN, the first utility message comprising a first utility value resulting if (a) the peer mobile entity were to be served by the network entity and (b) the first P2P link vacated an associated P2P resource;
receive at least one additional utility message from at least one additional mobile entity of at least one additional P2P link, the at least one additional utility message comprising at least one additional utility value resulting if the first P2P link vacated the associated P2P resources;
aggregate the first utility value with the at least one additional utility value to calculate a resulting utility value; and
send a trigger message to the WAN to initiate a handout of the peer mobile entity to the network entity, in response to the resulting utility value being greater than a current utility value of the first P2P link.

39. A method for controlling association changes between peer-to-peer (P2P) and wide area network (WAN) links by a mobile entity, comprising:
in an Interference-over-Thermal (IoT) projection based power control context with the mobile entity communicating with a second mobile entity being served by a network entity of the WAN, receiving a first utility message from the network entity, the first utility message comprising a first utility value resulting if (a) the peer mobile entity were no longer served by the network entity and (b) a first P2P link between the mobile entity and peer mobile entity were to become active on a given P2P resource;
comparing the first utility value to a current utility value of the first and second mobile entities communicating with each other via the WAN; and
sending a trigger message to at least one of the WAN and the second mobile entity to initiate a handout of the peer mobile entity to the first P2P link, in response to the first utility value being greater than the current utility value.

40. A method for controlling association changes between peer-to-peer (P2P) and wide area network (WAN) links by a mobile entity, comprising:
in a transmitter power spectral density (Tx-PSD) based power control context with the mobile entity in direct communication with a peer mobile entity via a first P2P link, receiving a first utility message from a network entity of the WAN, the first utility message comprising a first utility value resulting if (a) the mobile entity were to be served by the network entity and (b) the first P2P link were to use a given P2P resource with a first non-zero Tx-PSD setting;
receiving at least one additional utility message from at least one additional mobile entity of at least one additional P2P link, the at least one additional utility message comprising at least one additional utility value resulting if the first P2P link were to use the given P2P resource;
aggregating the first utility value with the at least one additional utility value to calculate a resulting utility value; and
sending a trigger message to the WAN to initiate a handout of the mobile entity to the network entity, in response to the resulting utility value being greater than a current utility value of the first P2P link.

41. A method for controlling association changes between peer-to-peer (P2P) and wide area network (WAN) links by a mobile entity, comprising:
in a transmitter power spectral density (Tx-PSD) based power control context with the mobile entity being served by a network entity of the WAN and communicating with a second mobile entity via the WAN, receiving a first utility message from a network entity of the WAN, the first utility message comprising a first utility value resulting if (a) the mobile entity were no longer served by the network entity and (b) a first P2P link between the first and second mobile entities were to become active on a given P2P resource with a first non-zero Tx-PSD setting;
receiving at least one additional utility message from at least one additional mobile entity of at least one additional P2P link, the at least one additional utility message comprising at least one additional utility value resulting if the first P2P link were to become active on the given P2P resource;
aggregating the first utility value with the at least one additional utility value to calculate a resulting utility value; and
sending a trigger message to at least one of the WAN and the second mobile entity to initiate a handout of the mobile entity to the first P2P link, in response to the resulting utility value being greater than a current utility value of the first and second mobile entities communicating with each other via the WAN.
